(19) United States
(12) Patent Application Publication
(10) Pub. No.: US 2024/0308011 A1
(43) Pub. Date: Sep. 19, 2024

(54) CABLE PROCESSING COMPRISING INFEED AND OUTFEED

(71) Applicant: Schleuniger AG, Thun (CH)

(72) Inventors: Michael ZBINDEN, Thun (CH); Willi BLICKENSTORFER, Stallikon (CH); Andreas NIEDERHÄUSERN, Thun (CH); Wolfgang FISCHER, Zug (CH); Thomas ZBINDEN, Rüeggisberg (CH); Simon BERGER, Mühlethurnen (CH)

(73) Assignee: Schleuniger AG, Thun (CH)

(21) Appl. No.: 18/550,758

(22) PCT Filed: Mar. 4, 2022
(86) PCT No.: PCT/IB2022/051939

§ 371 Date: Sep. 15, 2023

(30) Foreign Application Priority Data
Mar. 17, 2021 (WO) PCT/IB2021/052219
Jul. 19, 2021 (CH) CH070078/2021

(51) Int. Cl. B23Q 7/04; B65G 47/90; H01B 13/00

(52) U.S. Cl. CPC B23Q 7/048; B65G 47/907; B65G 2201/0217; H01B 13/0003

(57) ABSTRACT

A cable-processing system comprising a cable-processing machine for processing ends of cables. The cable-processing machine has: an input side for receiving the cables; a plurality of cable-processing stations; a cable transport device for transporting at least one cable with a movable gripper; and an output side for discharging a processed cable. The cable transport device has a cable conveying device designed as a multiple-store device having a plurality of cable holders. The multiple-store device is designed as an autonomous or guided transporter. At least one of the grippers is designed as a transfer gripper to remove the cables from the cable holder and to feed them to at least one of the cable-processing stations and/or to at least one further gripper acting as a transfer gripper which can be moved using a frame-supported transfer mechanism to transfer the cable to one of the cable-processing stations.

This application is a national stage completion of PCT/IB2022/051939 FILED Mar. 4, 2022, which claims priority from Swiss patent application no. 070078/2021 filed Jul. 19, 2021 and International application no. PCT/IB2021/052219 filed Mar. 17, 2021.

### FIELD OF THE INVENTION

The invention relates to a cable processing system according to the claims, which comprise a cable processing machine with a machine control for the automatic processing of cable ends of heavy, relatively rigid cables on a frame. Likewise an associated method for the automatic processing of cable ends of heavy, rigid cables according to the claims or a feed system for such cables according to the claims. This especially comprises a cable processing system in which pre-cut cable pieces or cable products of a defined length are processed, preferably on one or two cable ends, i.e. not a system that only works from the roll—i.e. almost endlessly—but a cable processing system for processing pre-cut cables or cable pieces, which are fed in the form of piece goods.

### BACKGROUND OF THE INVENTION

In cable processing machines, the cables are frequently fed to the machine or to one or more cable processing stations manually. This is particularly the case when cable ends of heavy, relatively rigid cables have to be processed, which frequently behave in an undefined and stubborn manner when they are to be moved, bent or twisted. This is especially the case with stiff or rigid, unyielding or inflexible cables, which can only be bent or twisted with effort and mostly elastically. For example, cables having cross-sections of 2.5 mm² to 150 mm², coaxial cables or cables having a total diameter >1 cm, multi-conductor cables 2.5 mm² to 6 mm², minimum bending radius equal to or greater than 17 to 270 mm, with shielding, with a thick inner conductor or with a large number of individual conductors, and/or with specially resistant sheaths, e.g. for power cables in motor vehicles, etc. Human workers can usually handle such cables intuitively or from experience, whereas automated or robotic systems repeatedly fail at least sporadically in such tasks, which can lead to machine downtime or defective parts. Such manual infeed and/or outfeed is not only tedious and expensive, but also error-prone, since with faster, imprecise or sloppy manual feeding, the machine cannot process the cables with precision and reproducibility. This also requires the permanent presence of at least one worker on one of the machines whilst this is in operation.

For short and thin cables, U.S. Pat. No. 5,125,154 or U.S. Pat. No. 5,152,395 shows a machine in which a whole box containing cables individually suspended on transport units moves through a machine during processing. DE 10 2016 116 453 also works with special cable boxes for each of the cables that are fed in as such.

In EP 2 565 992, freely suspended cable ends are guided around a rotary indexing table.

In cable processing machines, the cables are frequently fed to the machine or to one or more cable processing stations manually. This is particularly the case when processing cable ends of heavy, relatively rigid cables that frequently behave in an undefined and intractable manner when moved, bent or twisted. Stiff or rigid, unyielding or inflexible cables, which can only be bent or twisted with the application of force and mostly elastically, are particularly affected.

Examples are cables having cross-sections of 2.5 mm² to 150 mm², coaxial cables or cables having a total diameter >1 cm, multi-core cables 2.5 mm² to 6 mm², minimum bending radius equal to or greater than 17 to 270 mm, with shielding, having a thick inner conductor or having a large number of individual conductors, and/or having specially resistant sheathing, for example for power cables in motor vehicles, etc. Human workers can usually handle such cables intuitively or from experience, whereas automated or robotic systems repeatedly fail at least sporadically in such tasks, which can lead to the stoppage of the machine or to defective parts. Such manual infeed and/or outfeed is not only tedious and expensive, but also error-prone, since with faster, imprecise or sloppy manual feeding, the machine cannot process the cables with precision and reproducibility. This also requires the permanent presence of at least one worker on one of the machines whilst it is in operation.

Apart from the fact that this would not be feasible with heavy, thick and rigid cables, such cable processing systems are in need of improvement in terms of efficiency, accuracy and reliability in cable processing. A disadvantage of these known solutions is, for example, that especially such rigid or stiff cables cannot be handled in the same way as conventional standard cables.

### SUMMARY OF THE INVENTION

An object of the present invention is therefore to provide a cable processing system which does not have the aforesaid disadvantages and, in particular, provides fast and reliable cable processing, which preferably also does not depend on the permanent presence and skill of a worker. The sequences of the cable processing should also be easier to integrate into a higher-level, automated, electronic production or factory management system, e.g. be geared towards Industry 4.0.

The object is solved by the features of the independent claim. Advantageous further developments are presented in the figures and in the dependent claims.

According to the invention, a cable processing system is provided. This system comprises a cable processing machine with a machine control for the automatic processing of cable ends of heavy, relatively rigid, pre-cut cables on a frame. The system according to the invention is specially configured to be fed with cables in the form of pre-cut cable pieces on which at least one, preferably both cable ends are processed. The cables can be provided specifically as substantially straight pieces of a defined cable length, or in the case of longer cables also as cable coils with a predefined cable length, which coils are also transported and the ends of which are kept at least approximately straight. Cable end means not only the blunt end of a cut surface of the cable, but a cable end area, i.e., for example, an area at the end of the cable, in particular of e.g. 5 m or 10 cm or up to about 30 cm.

The machine has an input side for receiving the cables to be processed and an output side for delivering the processed cables. The cable is processed between the input side and the output side, preferably—but not necessarily—processing of the cable ends, e.g. by means of a stripping, twisting, bending, crimping, mounting, finishing, etc. which is carried out with at least one, preferably with at least two or more frame-supported cable processing stations. The cable processing machine is configured on a frame, which means that the cable processing stations are combined as a unit in one machine and are not scattered in a factory building. For example, the cable processing stations can be connected to one another and/or by means of a frame construction to form a machine and can preferably also be combined under a common housing.

The cable processing system according to the invention also has a cable transport device for transporting at least one cable. In the cable processing machine, this cable transport device has at least one, also frame-supported, movable gripper for the cable. Such a gripper is configured on the one hand with a sub-area configured as a gripping system for detachably holding a cable or cable end, for example with a type of pincer gripper with movable jaws or another device for detachable positive and/or non-positive clamping of a cable, a vacuum holder or an adhesive, magnetic or gravitational, detachable holding device—with or without a corresponding sensor system for determining whether and/or how a cable is currently being held. The gripper is configured to be movable, which means that it is configured to move the cable in relation to a machine base, i.e. for example the frame, the cable processing stations and/or the input or output side. The transport system and/or the moveable gripper therefore has at least one rotary or linear movement axis.

According to the invention, the cable transport device is equipped with a cable conveying device configured as a multiple-store device, which has several cable holders for respectively one of the cables or at least one cable end of the cable. This is specially configured as an actively conveying cable conveying device to actively convey a plurality of cables, i.e. to move the cables with an active mechanism in order to further move the cables contained in the multiple-store device within the multiple-store device and in relation to it. This is possibly a cable conveying device in the form of a conveyor belt, a walking beam conveyor, a chain conveyor for preferably separable chains with quick-release fasteners in the segments, etc.—specifically as described and/or outlined in more detail hereinafter.

The cable holders can be configured, for example, as clamps, supports, compartments or separators (pairs) for one of the cables or one of the cable ends, which are moved with the cable conveying device in the multiple-store device, specifically as described below by way of example. Two cable holders spaced apart from one another are preferably used for a cable, preferably with one of them configured as a clamp and the other as a support. A clamp is, for example, an element that clamps the cable in a partial area of its circumference between two elastic, substantially parallel parts that partially enclose the cable with an application of force. A support can be configured, for example, as a recessed shape in which the cable comes to rest due to gravity, and preferably hold the cable laterally in a defined positional area by lateral separating webs without clamping the cable with an application of force between the separating webs.

According to the invention, at least one of the grippers is configured as a handover gripper. This is specially configured to remove one cable after the other from the respective cable holder and pass it on to another gripper as a transfer gripper and/or to one of the cable processing stations. Such a transfer gripper and/or transfer/handover gripper is configured to be movable with a frame-supported transfer mechanism in order to carry out a handover of the cable from one of the cable processing stations to another of the cable processing stations. The at least one handover gripper is also moved by a transfer mechanism.

The handover gripper preferably has two pairs of gripper jaws for gripping a first and a second conductor of the cable. Thus, a cable having more than one conductor can be picked up and transported in a stable manner.

In particular, the pairs of gripper jaws are arranged on a gripper transfer guide and can be moved along the gripper transfer guide, so that their distance from one another can be adjusted. The distance between the pairs of gripper jaws can be set individually and reproducibly, depending on the cable type and the distance between the two conductors of the cable.

In particular, the transfer gripper has two pairs of gripper jaws for gripping the conductor. The transfer gripper can simply transfer the cable removed from the cable storage to the transfer gripper, which feeds it to at least one, preferably at least two or more cable processing stations for processing. The pair of gripper jaws of the handover gripper change their distance from one another before or during the handover so that the conductors fit into the pair of gripper jaws of the transfer gripper and can then be easily fed individually to the cable processing stations.

The cable conveying device can preferably be docked by means of a docking mechanism on the input side of the cable processing machine in a defined positional relationship, especially at least during operation of the cable processing machine. Depending on the embodiment, the cable conveying device can substantially only be attached temporarily (e.g. as a wagon or similar) or substantially permanently (e.g. mounted fixedly) to the input side of the cable processing machine.

The docking mechanism preferably has a mechanical guide for the positioned docking of the multiple-store device on the cable processing machine. For example, with a mechanical, magnetic or electronic infeed device for such a transporter, with which it can preferably be positioned in a defined manner in relation to the cable processing machine. In this case, for example, a sensor for determining a docking and/or a docking position, a locking device for locking and unlocking the docking, an inlet damper for the transporter, etc. can also be provided. With these for example, a safe and defined docking of the transporter on the cable processing machine can be achieved.

The cable conveying device is preferably supported on a floor- or ceiling-supported transporter, which can be moved independently of the cable processing machine. For example, such a transporter can be configured as a wheeled transport system-such as a wagon or trolley or the like-either freely movable or rail-bound. Another example would be a ceiling or wall-bound transport system-such as a gondola or the like.

A detachable coupling is preferably formed between the multiple-store device and the cable processing machine. Such a coupling can be formed in particular in the area of the docking mechanism. This detachable coupling is specially configured in such a manner to bring a drive of the cable processing machine into a mechanical operative connection with the cable conveying device when docking. This can be accomplished, for example, by means of gear wheels, which interact in the coupled state. In a preferred embodiment, possibly one of these gear wheels can be rotatably mounted in an intermediate wheel holder, which intermediate wheel holder is preferably rotatably mounted about another gear wheel and this rotatable mounting is pre-tensioned with a passive force element. In this case, all of the gear wheels can preferably be separated from the surroundings by a casing. This casing has an opening which is closed by a closure element during transport of the multiple-store device, which closure element has a mechanism which releases this opening when docking in order to make the gear wheel required for coupling accessible. The closure element can for example, be a flap, a slider or the like.

As an alternative to the detachable coupling, the cable conveying device has a local drive. This can be connected to a preferably local controller, which interacts with the machine controller in the operating state.

In the docked state, the multiple-store device preferably has a removal area and/or an insertion area for the cables, which areas are separated from the grippers and/or from one another by a housing of the cable processing machine and can preferably be operated manually.

In one embodiment, the multiple-store device can be continuously docked to the cable processing machine whilst it is in operation, and the areas outside the housing can be loaded or unloaded with the cables continuously of cyclically during operation. Optionally, a docking mechanism that can be detached during operation can also be completely dispensed with and the multiple-store device can therefore be a fixed part or a permanently installed module of the cable processing machine. Thus, continuous operation of the machine can be achieved. In particular, a plurality of cable processing systems according to the invention can be operated in parallel with cyclic loading or unloading, e.g. with an alternate operation of their removal areas and/or depositing areas. Optionally, a fill level can be monitored automatically, for example with a warning if the fill level in the depositing area is low or the removal area is almost full.

In another embodiment, after docking, the multiple-store device can also be substantially completely accommodated within a housing of the cable processing machine. A loading or unloading of the multiple-store device can then, for example be accomplished by undocking the multiple-store device, whereupon the same or another loaded multiple-store device is docked again.

Each of the cable holders preferably has at least one web or driver, a support and/or a clamp. In this case, preferably one clamp and one support can be arranged in parallel on a common belt and/or chains or on two belts and/or chains running synchronously with one another. The clamps can comprise elastic elements, the pre-tensioning of which can preferably be adjusted. The clamps can be fixed in receptacles, which are guided by guides along the conveying direction of the belts and/or chains.

If necessary, a suspended or coil transport device is preferably additionally provided for transporting cable coils. In such a case, each cable coil can be moved in a designated suspended or coil transport unit, preferably synchronously with the movement of the associated cable ends using the gripper. The cable processing machine is preferably configured in such a manner that thin cables, standard cables and thick, rigid cables can be processed with the same machine, in particular without having to make significant modifications to a the machine. In preferred embodiment, both short cable pieces of, for example, several tens of centimetres, as well as long cables of several meters can be processed, especially by using a suspended transport device of the cable processing machine for the longer cables in addition to the multiple-store device for the cable ends. For example, a multiple-store device according to the invention can also be configured in such a manner that non-rigid cables can also be provided or conveyed with this.

Preferably, the transporter—as an alternative to an embodiment with a transporter moved by muscle power—is configured with a drive device for moving the transporter.

For example, the transporter can be equipped as an autonomous or guided vehicle with its own driving control for at least partially autonomous navigation. The driving control of the transporter can be configured for communication with the machine control and/or with a higher-level control system. Optionally, the transporter can also be configured to be coupled to an autonomous transport system of a factory and moved in a controlled manner.

In one embodiment, at least one magazine is preferably arranged on the input side above at least a partial area of the cable conveying device, which is configured with an actuatable underside in such a manner that cables located in the magazine can be released downwards into the cable conveying device and/or another magazine with the aid of an actuating device, for example with flaps, sliders or similar on the underside. The magazine or a group of several magazines can preferably be moved with the aid of a transporter and/or can preferably be docked to the cable processing machine with the aid of a docking mechanism.

Preferably, at least one magazine for accommodating processed cables is arranged on the output side with an actuatable underside, which underside is configured in such a manner that cables located in the magazine can be released downwards with the aid of an actuating device, e.g. similarly as previously described. In particular, the magazine can be configured with an actuatable underside in such a manner that cables located in the magazine can be released downwards into the cable conveying device, another magazine and/or a transport or storage box with the aid of an actuating device. Here also the magazine or a group of several magazines can preferably be moved with the aid of a transporter and/or can preferably be docked to the cable processing machine with the aid of a docking mechanism.

Preferably, the cable transport device is configured on the output side with a further cable transport device configured as a multiple-store device, which has several further cable holders. This cable transport device can also be dockable by means of a docking mechanism on the output side in a defined positional relationship. A second moveable gripper of the cable transport device is configured to remove one cable after the other from one of the cable processing stations and to feed it to the respective further cable holder. Preferably, the multiple-store devices for the input side and/or the output side can be configured to be the same or at least of the same type and can be interchangeable.

At least one defective parts magazine is preferably arranged on the output side, which is provided in order to deposit therein cables recognized as defective parts by the cable processing machine, preferably marked as “defective”. The defective parts magazine can preferably be arranged above or next to a multiple-store device on the output side in such a manner that it can be operated by the movable gripper. For example, the defective parts magazine can also be configured as an additional transporter. Accordingly, only the cables recognized and/or marked as “good” by the cable processing machine are deposited in the output-side cable holder.

In one embodiment, the cable conveying device is preferably configured with at least one chain, in particular an open chain, configured as a multiple-store device, the chain segments or chain links of which can be separated and which each have at least one of the cable holders. The chain segments are specially configured in such a manner that they can be easily separated from one another or connected to one another, i.e. in particular without special tools, e.g. possibly by suspending or removing or—clipping of additional chain links at the beginning or end of the chain, by a user and/or by automated stations and/or assemblies in the cable processing machine. Thus, for example, the chain can be provided as a quasi-endless multiple conveying device whereby the chain is lengthened with further chain segments during operation of the cable processing machine or is shortened by chain links that have already been used. The cable processing machine or the cable conveying device preferably comprises a drive which is configured in such a manner that the chain can be conveyed with it, especially when the chain is not tensioned, i.e. for example, not closed, but is provided with open ends. For example, with an at least one-sided, preferably two or three-sided chain guide and a driven chain conveyor element (chain gear wheel, double toothed belt with the outer teeth matching the chain, walking beam drive, ram, or the like). The chain segments are preferably fed into or removed from the machine on transport units such as wagons or the like. The empty chain segments are preferably collected or stored in chain supply collection containers in the area of the cable conveying devices, for example in boxes or on rollers. Additional sensors are preferably used here, preferably cameras, in order to monitor the fill level. Alternatively, the two cable conveying devices on the input and output side can also be connected to one another such that the empty chain segments on the input side are conveyed directly to the output side. Another sensor can also be provided for detecting the input-side end of the chain, in order to stop the machine in good time before the end of the chain.

Preferably, the overall system can also have at least one further gripper with an associated transfer drive outside the housing of the cable processing machine, which is arranged and configured such that it serves the removal area and/or the depositing area of the multiple-store device. This further gripper can in particular provide a transfer of a cable between the removal or depositing area and an external ceiling or floor-bound transport system outside the cable processing machine, for example an external trolley or wagon with which the cables in a factory are removed or provided manually or automatically. Alternatively and/or additionally, further grippers with the associated transfer system can also be used in order to move not only the cables or the cable ends, but also the coils of long cables.

The cable processing machine and/or the cable transport device is preferably equipped with at least one sensor, which is configured to provide information about the number and/or position of the cables, specifically in a multiple-store device, in a cable conveying device, in an alternative multiple transport device and/or in a magazine as described here. For example, the sensor can be configured as a camera for image recognition, a counting device, an optical, inductive and/or capacitive sensor.

The cable processing machine preferably has an intermediate buffer store for cables on the input side and/or on the output side between the multiple-store device and the cable processing device. This is configured with at least one additional cable holder for storing at least one of the cables within the cable processing machine and can be operated with a gripper. Such an intermediate buffer store can in particular be configured in such a manner that for a defined time window during docking and undocking of a multiple-store device it holds cables for/from the cable processing station, or cable for or from a further gripper and/or the output-side multiple-store device.

Similarly, the invention also relates to a method for the automatic processing of cable ends of heavy, relatively rigid cables. This is accomplished at least by accommodating or providing several of the cables in several cable holders of a multiple-store device configured as a cable conveying device.

This multiple-store device can be a fixed part of the cable processing machine, or preferably a mobile multiple-store device, which is provided by docking the multiple-store device on an input side of a cable processing machine. This can be accomplished in particular with an at least partial introduction of the multiple-store device, which is preferably configured to be mobile, into a housing of the cable processing machine.

In a first, simple embodiment variant, at least one cable or one cable end of one of the cables is removed mechanically from the multiple-store device using a handover and transfer gripper of the cable processing machine. Furthermore, feeding the cable or cable end to at least a first cable processing station by the handover and transfer gripper is accomplished with the aid of at least one associated transfer drive. After the cable or cable end has been processed in the first cable processing station, the cable or cable end is transferred from the first cable processing station to at least one second cable processing station by the handover and transfer gripper. After the cable or cable end has been processed in the second cable processing station, the processed cable or cable end is removed from the second cable processing station by the handover and transfer gripper.

In the simple embodiment variant of the invention, the method can also be carried out whereby all the movements of the cable or cable end are only carried out by a single handover and transfer gripper and its transfer drive. All of the aforesaid handover and transfer grippers can therefore be configured as a single gripper and no handover between different grippers can take place. For example, the removal from the input-side multiple-store device, the feeding to the cable processing station or stations and the depositing in the output-side multiple-store device can be accomplished with only a single handover and transfer gripper and its transfer drive.

In a second, expanded embodiment variant, at least one cable or cable end of one of the cables is removed mechanically from the multiple-store device with a first handover gripper and at least one associated transfer drive of the cable processing machine by the same. Furthermore, the cable or cable end is transferred from the first handover gripper to a transfer gripper with the aid of at least one transfer drive associated therewith, and the cable or cable end is fed to at least a first cable processing station by the transfer gripper with the aid of at least one transfer drive associated with this. The cable end is processed in the cable processing station and the cable or cable end is then transferred from the first cable processing station into at least a second cable processing station by a transfer gripper with the aid of at least one transfer drive associated therewith, followed by processing the cable or cable end in the second cable processing station. Optionally, further cable processing stations can also follow in the same way. After the last of the cable processing stations, the processed cable or cable end is removed from the second cable processing station by a transfer gripper with the aid of at least one transfer drive associated therewith, and the cable or cable end is handed over from this transfer gripper to a second handover gripper with the aid of at least one transfer drive associated therewith.

In the extended embodiment variant, the method can be carried out by moving the cable or cable ends with a plurality of transfer grippers, with at least one further handover gripper being provided for handing over the cable end between these at least two transfer grippers.

The cable conveying device is preferably moved by driving the cable conveying device by means of a power transmission from the cable processing machine to the multiple-store device. In this case, in particular, a mechanical coupling can take place during docking, through which coupling the power transmission takes place.

Alternatively, the cable conveying device can be moved by driving the cable conveying device by means of a local drive on the multiple-store device. In this case, the supply of the local drive with a local power supply to the cable conveying device and/or with an electrical coupling of the cable conveying device to the cable processing machine can be accomplished during docking.

Preferably, the cables or cable ends can be clamped or deposited in the cable holder, preferably manually and outside of a housing of the cable processing machine.

Preferably, at least one suspended transport unit for a cable coil of a respective cable is co-moved, at least during feeding and transfer of the cables or cable ends in the cable processing machine.

Preferably, the method also comprises a floor- or ceiling-bound spatial movement of the multiple-store device in a factory environment. In particular, this movement also comprises the preferably automatic docking and undocking at the cable processing machine. For example, this movement can take place by means of an autonomously controlled transporter, in particular with preferably autonomous navigation and/or communication of a local control unit of the multiple-store device with the cable processing machine, especially at least during docking. In this case, for example, when the transporter is introduced, preferably automatic, precisely positioned docking of the multiple-store device to the cable processing machine can take place, in particular whilst producing a mechanical and/or electrical coupling between them.

Preferably, as part of the method, the cables are also fed to the cable conveying device with at least one magazine for a plurality of cables. The cable can then be fed to the cable conveying device by means of gravity and/or passed on to a magazine located thereunder by means of gravity, e.g. by releasing an underside of the magazine by an actuating device in the area of the magazines.

Preferably in the course of the method, the processed cables are additionally or alternatively also removed with at least one magazine for the cables. In this case, for example, the cables are passed onto a magazine located thereunder by means of gravity by releasing an underside of the magazine by an actuating device in the area of the magazine. The depositing of the processed cable into the uppermost magazine is preferably carried out here directly by the gripper, without a further cable conveying device also being present on the output side.

The cables are preferably provided and/or removed by actuating an actuatable underside. As a result of this actuation—for example, a flap, push, or the like, of the underside of a magazine-a dropping of the cables from one section of the magazine into the cable holder located below or into another section of the magazine located thereunder can be triggered. In this case, the magazine is preferably assigned to the multiple-store device or the cable conveying device.

A docking of a second multiple-store device on an output side of the cable processing machine preferably also takes place as part of the method. The cable or cable end can preferably also be deposited mechanically in a cable holder of the second multiple-store device on the output side of the cable processing machine, specifically by a transfer or handover gripper, preferably by a second handover gripper and with the aid of a transfer drive associated therewith.

In the method, an automatic detection of defective parts is accomplished in the cable processing machine and these defective parts are deposited in a separate defective parts magazine. This can be accomplished in particular on the output side of the cable processing machine and preferably with an automatic marking and/or rendering the defective parts unusable, preferably in a cable processing station provided for this purpose.

Preferably, the cables can be fed in and/or removed with a cable conveying device with at least one open chain as a multiple-store device. The chain links or chain segments of the chain comprise the cable holders and can be easily separated from one another. By separating and/or connecting the chain links or chain segments at the beginning or end of the chain, the chain segments of which contain the unprocessed or processed cables, the cables are fed in or removed, preferably by providing the chain segments on wagons or the like and connected to a chain part provided at the cable processing machine or separated from this. The empty chain segments at the other end of the chain are preferably collected or stored in chain supply collection containers or directly on the wagons; or the two chains on the input and output sides are connected to one another in such a manner that the empty chain segments on the input side are conveyed to the output side and serve as storage there.

Preferably, the cables can also be fed in and/or fed out using a cable conveying device with at least one external gripper outside the housing. This external gripper transfers a cable between an external ceiling or floor-bound transport system outside the cable processing machine and a removal area and/or depositing area of the multiple-store device located outside the housing.

Preferably, a number of cables are temporarily stored in an intermediate buffer store within the cable processing machine, between the multiple-store device and one of the cable processing stations by means of a gripper.

In other words, an embodiment of the invention also relates to a feed system for heavy, relatively rigid cables to a cable processing machine in which an automatic processing of cable ends of the cables takes place in at least one cable processing station or cable finishing device of the cable processing machine. This feed system has a cable transport unit, which is configured as a floor or ceiling-bound transporter, which can be docked to the cable processing machine with a docking mechanism between the transporter and an input side of the cable processing machine. The cable transport unit comprises a plurality of cable holders in the form of a multiple-store device, which cable holders are configured in such a manner that one of the cable ends can be removed mechanically from a cable transport device of the cable processing machine and fed to several cable processing stations for processing the cable ends. The transport device can be specially configured in such a manner that the cable transport unit remains on the input side and the cable is moved separately from the cable transport unit to and from the cable processing stations in the cable processing machine.

In other words, one embodiment of the invention also relates to an outfeed system for heavy, relatively rigid cables from a cable processing machine, which is configured to automatically process cable ends of the cables in at least one cable processing station or cable finishing device of the cable processing machine. The outfeed system comprises a cable transport unit, which is configured as a floor or ceiling-mounted transporter, which can be docked to the cable processing machine with a docking mechanism between the transporter and an output side of the cable processing machine. The cable transport unit has several cable holders in the form of a multiple-store device, which cable holders are configured in such a manner that one of the cable ends can be removed from at least one of the cable processing stations of the cable processing machine mechanically by a cable transport device and can be deposited in this cable holder. The transport device can be specifically configured in such a manner that the cable transport unit remains on the output side and the cable is moved separately from the cable transport unit to and from the cable processing stations in the cable processing machine.

Accordingly, the invention also relates to a system comprising a cable processing machine and at least two cable transport units and with an aforesaid infeed system and/or outfeed system.

Also included by reference is International Patent Application PCT/IB2021/052229 filed on the same day by the same applicant and with the same principal inventor, which also relates to “cable processing with infeed and outfeed”.

Specially included are those paragraphs which describe the suspended transport device and their embodiments in further detail, which can be applied to this invention in a similar manner.

Further advantages, features and details of the invention result from the following description, in which exemplary embodiments of the invention are described with reference to the drawings.

Like the technical content of the claims and figures, the reference list is part of the disclosure. The figures are described coherently and comprehensively. The numbers reference and their descriptions are to be considered across all figures, especially if they are not explicitly differentiated. The same reference symbols denote the same components, whilst reference symbols with different indices indicate functionally identical or similar components. Functional and logical relationships between the number ranges used are also clearly apparent to the person skilled in the art. The drawings are symbolic representations. Naturally, all load-bearing parts are appropriately connected to one another (e.g. via a frame construction), even if this is not explicitly recognizable from the drawings in some places (e.g. for improved identifiability of other features).

### BRIEF DESCRIPTION OF THE DRAWINGS

In the figures:

FIGS. 1a to 1i show schematic diagrams of different embodiments of a system according to the invention comprising a cable processing machine and the associated cable processing transport system,

FIG. 2a and FIG. 2b show an isometric view of the embodiment according to FIG. 1c, once with both cable transport units docked to the cable processing machine (FIG. 2a) and once detached (FIG. 2b),

FIGS. 3a and 3b show a further detailed view of FIG. 2b with some elements hidden for a better view of the cable holders on a cable transport device designed as a conveyor belt,

FIGS. 4a to 4d shows various sectional and detailed views of FIG. 2a and/or FIG. 2b, viewed in the direction of the arrows drawn there, with some elements hidden for a better view of the coupling and the docking mechanism,

FIG. 5a and FIG. 5b show a special embodiment of the cable transport unit for transporting coiled cables, similar to that shown in FIG. 1e,

FIG. 6 shows an isometric view of a cable coil conveying device or multiple transport device for several suspended transport units designed here as a walking beam,

FIG. 7a to FIG. 7e shows the mode of operation of a multiple transport device with walking beam drive principle and rotary, preferably electric drive,

FIG. 8a to FIG. 8f show the mode of operation of a multiple transport device with a walking beam drive principle and a translational, preferably pneumatic drive,

FIG. 9 shows a schematic diagram of a further embodiment of a system according to the invention according to FIG. 1a to FIG. 1h comprising a cable processing machine and the associated cable processing transport system,

FIG. 10 shows a cable for a system according to FIG. 9 in a schematic view,

FIG. 11 shows a multiple-store device for a system according to FIG. 9 in a perspective view,

FIG. 12 shows an embodiment for a handover gripper for a system according to FIG. 9 in a perspective view, and

FIG. 13 shows an embodiment for a transfer gripper for a system according to FIG. 9 in a perspective view.

### DETAILED DESCRIPTION OF THE PREFERRED EMBODIMENTS

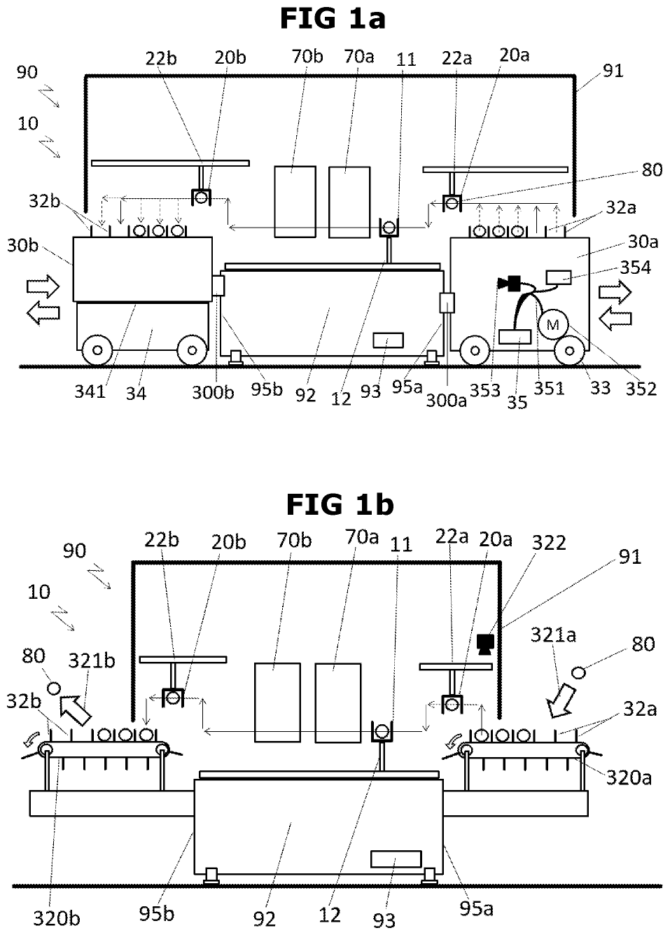

FIG. 1a to FIG. 1i show schematic diagrams of various embodiments of a system according to the invention comprising a cable processing machine 90 and the associated cable transport system 10, which in some designs extends outside the cable processing machine 90.

In the embodiment in FIG. 1a, this cable transport system 10 consists of at least one transfer gripper 11, two handover grippers 20a, 20b, the transfer mechanisms 12, 22a, 22b belonging to the grippers, and two groups of cable transport units 30a, 30b for transporting a plurality of cables 80. These cable transport units 30a, 30b are configured as wagons or trolleys and can move independently of the cable processing machine 90. The wagons 30a used for loading the cable processing machine 90 can dock at the input side 95a of the cable processing machine 90 with the aid of the docking mechanism 300a. The wagons 30b used for unloading the cable processing machine 90 can in this case dock on the output side 95b of the cable processing machine 90 with the aid of the docking mechanism 300b. Depending on the embodiment, the wagons 30a and 30b can each be configured differently, i.e. specifically either for the input side 95a or for the output side 95b, or the wagons 30a and 30b can also be configured in the same way, so that the same wagon 30a, 30b can be used on the input side 95a or at the output side 95b.

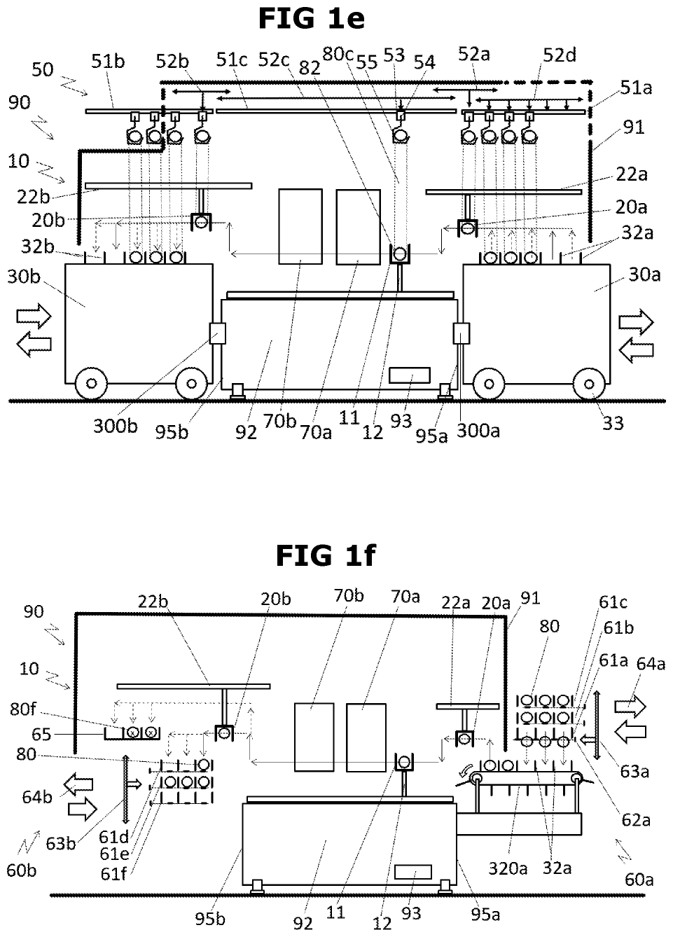

A plurality of cable holders 32a, 32b are provided in each of the two wagons 30a, 30b. These can either be configured as simple dividers (as shown here in FIG. 1a) or supports 324 (as shown in FIG. 3a), but also as spring-loaded cable clamps 323 (as shown in FIG. 1h, FIG. 3a and FIG. 3b). Several cable holders 32a, 32b are preferably used per cable 80, preferably in combination with a clamp 323 and a support 324, e.g. as shown in FIG. 3a.

For processing the cables 80, these are successively removed from a cable holder 32a or a pair of cable holders 323, 324 of the loading wagon 30a by the first handover gripper 20a. The handover gripper 20a transfers the removed cable 80 to the transfer gripper 11, which feeds it to at least one, preferably at least two or more cable processing stations 70a, 70b for processing. For this purpose, in addition to the two grippers 20a and 11, the transfer mechanisms 12 and 22a respectively associated with them also move. After completing all the processing in the two cable processing stations 70a, 70b shown here as an example, the cable 80 is transferred from the transfer gripper 11 and the transfer mechanisms 12 and 22b to another handover gripper 20b in the area of the output side 95b, which then deposits or transfers it into a cable holder 32b or a pair of two cable holders 32b of the unloading wagon 30b.

Alternatively, the cables can also be deposited directly in a transport or packaging box for finished cables.

Thus, one cable 80 after the other can be processed fully automatically until the loading wagon 30a is empty and/or the unloading wagon 30b is full-represented by the thin arrows which illustrate the movement of the cable 80, wherein solid lines represent the current movement and broken lines represent other possible movements. All the grippers 11, 20a, 20b and the associated drive axles or transfer mechanisms 12, 22a, 22b for their movement are part of the cable processing machine 90 and connected to its controller 93, e.g. via various control cables (not shown). All the transfer mechanisms 12, 22a, 22b as well as all cable processing stations 70a, 70b, . . . are attached to the frame or framework 92 of the cable processing machine 90. To ensure the safety of the user, a housing 91 or some other safety device such as a light curtain, etc. can be provided. This is designed in such a manner that it covers at least the travel range of all grippers 11, 20a, 20b and transfer mechanisms 12, 22a, 22b but still does not impede the moving in and out of the wagons 30a, 30b (represented by block arrows). A safe loading and/or unloading of cables 80 can thus also take place during the operation of the cable processing machine 90.

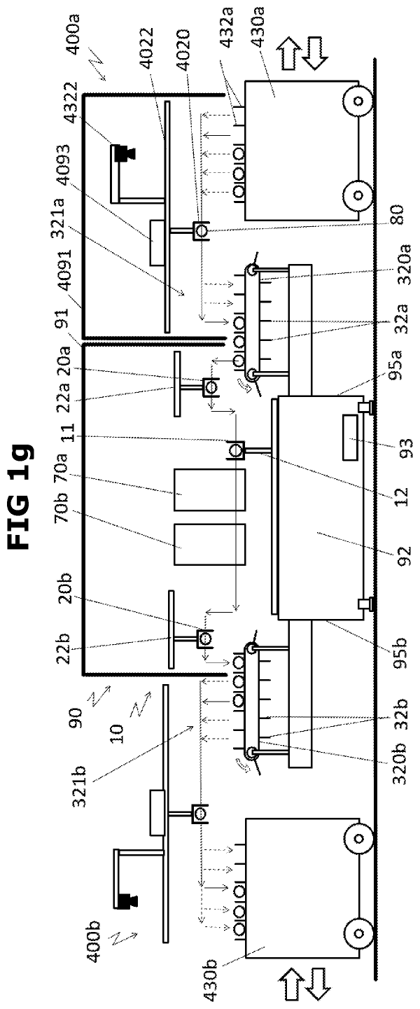

The docking mechanisms 300a, 300b are configured in such a manner that they enable the wagons 30a, 30b to be easily and reliably docked to the cable processing machine 90 and also to inform its controller 93 whether a wagon 30a, 30b is actually docked or not. Preferably, the docking takes place with a defined position from the wagon 30a, 30b to the machine 90, so that a known removal or depositing position for the cable 80 is given. In addition or alternatively, such a positional relationship can be determined by means of sensors 3042 and made available to the controller 93 of the cable processing machine 90—as is shown, for example, in the exemplary embodiment in FIG. 4a and FIG. 4b. Additional sensors 3042, locking devices 304 and/or mechanical guides 301, 303 and run-in surfaces are preferably used for this purpose, which is explained in more detail hereinafter.

The multiple-store devices 30a, 30b, i.e. the wagons 30a, 30b in the figure shown, can be designed in various embodiments from very simple to “intelligent” or fully autonomous, wherein the actual transporter 34 can be designed to be separable from the multiple-store device area with the cable holders 32a, 32b and/or from the docking mechanism 300a, 300b. Schematically shown in FIG. 1 is an embodiment as an intelligent wagon 30a on the input side 95a, for example with its own controller 35, drive motors 352 for moving the moving elements 33, sensors 353 for navigation, an energy supply 354 and cables 351 which all connect these elements, etc. The controller 35 can be specially configured in such a manner that it can communicate with the controller 93 of the cable processing machine 90, the controller 35 of other wagons 30a, 30b or a central overall controller, preferably wirelessly. Cameras, for example, are used sensors 353, preferably supported by other sensors and software processes that provide the information required for (indoor) vehicle navigation (LIDAR, RFID, proximity sensors, guidance systems, IPS (“indoor GPS”), triangulation methods, SLAM, etc.). A rechargeable battery (accumulator) is preferably used as the energy supply 354, which can be charged, for example, in the docked state. The power supply for operation and/or charging can also be wireless or contactless via induction or current collectors with sliding contacts.

Wheels are preferably used as moving elements 33 in the case of floor-based wagons, ideally 4 per wagon 30a, 30b.

For maximum manoeuvrability in tight spaces, for example, Mecanum wheels with additional rollers in the wheel (e.g. as in U.S. Pat. No. 3,876,255), driven by respectively one motor 352, preferably a geared electric servo motor can be used. In addition, alternative drive principles can also be used, for example with balls similar to those in old computer mice, classic wheels and swivel joints, and/or leg-like moving elements for overcoming steps and/or other obstacles. The wagons 30a, 30b can also be configured with wheels suitable for rails, an air cushion bearing with a suitable drive and/or a magnetic levitation track. In addition to floor-based transport systems, wagons the 30a, 30h can alternatively also be configured to be ceiling- or wall-mounted in other embodiments.

In minimal embodiments of wagons 30a, 30b according to the invention, drive elements and/or sensors can also be completely dispensed with. Such wagons 30a, 30b can, for example, be moved and/or docked or undocked by the operator himself—e.g. similar to a shopping cart in the supermarket. Arbitrary intermediate stages of the wagons 30a, 30b can be formed between this minimal and a fully autonomous embodiment and, if necessary, also be used jointly in a system.

It is particularly advantageous if the manufacturer of the cable processing machine 90 largely leaves this decision to his customers and only provides the cable holder 32a, 32b and the docking mechanism 300a, 300b; with a simple and clearly defined mechanical interface 341 to the actual wagon 34, which can then be provided by the customer according to his needs and equipped with the aforesaid components. An embodiment of such a structure is shown schematically on the left on the output side 95b of FIG. 1a. The multiple-store device 30b, specifically the cable holders 32b and their support structure with the attached docking mechanism 300b is attached to the transporter 34, for example, via the easily detachable, mechanical interface 341. This transporter 34 can be procured by the customer himself, e.g. as a standard product and/or an existing transport system can be used. Here he can decide for himself whether very simple and inexpensive transporters 34 are to be used for self-pushing, whether intelligent wagons 35 with control, drive and navigation are to be used, or a mixed operation of these should take place. When deciding on an intelligent wagon 35, a model from the same manufacturer can be selected as is already used elsewhere at the same location, which is equipped according to the invention with the multiple-store device 30a, 30b and possibly with a mechanical or virtual/sensor-based docking mechanism. A subsequent upgrade is also possible at any time, for example by transferring the cable holder 32b and/or the docking mechanism 300b to a motorized and/or autonomous transport system, e.g. with the interface 341. If the wagon 30a is changed immediately after the last cable has been removed and preferably whilst it is still being transported through the machine, any downtime of the machine 90 can be reduced or avoided. For this purpose, intermediate buffers 40a, 40b are preferably used, e.g. as shown subsequently in FIG. 1d.

FIG. 1b shows an alternative embodiment according to the invention with a cable transport device 10, in which the cable holders 32a, 32b are not mounted in a fixed position (as shown in FIG. 1a), but are configured as a cable conveying device 320a, 320b—in the example shown but not necessarily, on both sides of the cable processing machine 90. In another embodiment, e.g. the input side 95a as shown and the output side 95b can be accomplished with a simple deposition of the finished cable in a transport box, possibly on a wagon 34 (not shown). The cable conveying devices 320a, 320b shown here are part of the cable processing machine 90, in particular firmly connected to the frame 92, and controlled by the controller 93. Separate, cable transport units 30a, 30b separable from the machine 90 (as in FIG. 1a) are not provided. The travel path of the transfer mechanisms 22a, 22b for the handover grippers 20a, 20b can be made correspondingly shorter, and likewise the mechanical or virtual housing 91 for personal protection from moving machine parts.

These cable conveying devices 320a, 320b are preferably configured as a conveyor belt, for example as explained in the example of FIG. 3a with at least one drive belt 3203, 3204 and cable holders 32a, 32b fastened thereon preferably on a first frame 3203 implemented as clamp 323 and on a second belt 3204 implemented as a support 324.

As described in more detail in the embodiment of FIG. 1h, alternatively to this, chains 3205a, 3205b can be used instead of belts 3203, 3204, preferably with chain segments 3206 that are easily separable from another and especially with a drive 3111, which also functions without tensioning of the chain 3205a, 3205b.

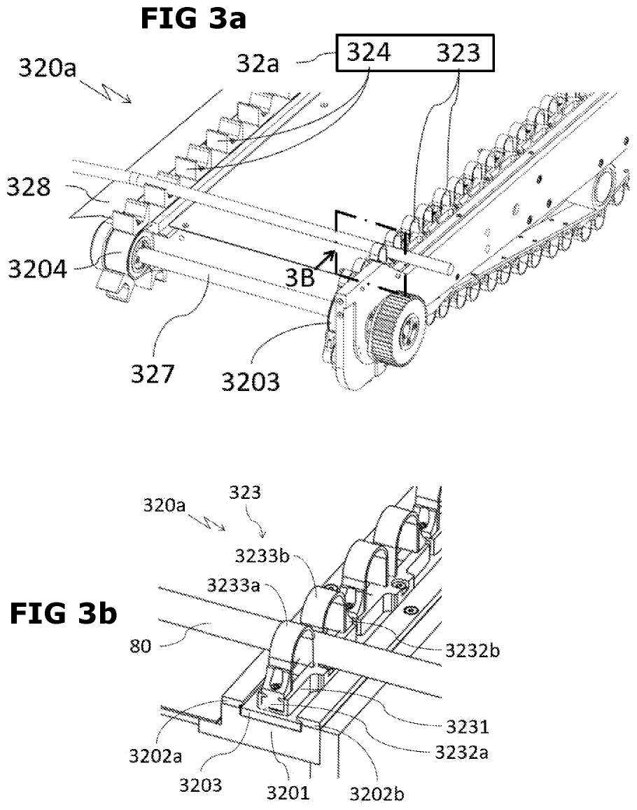

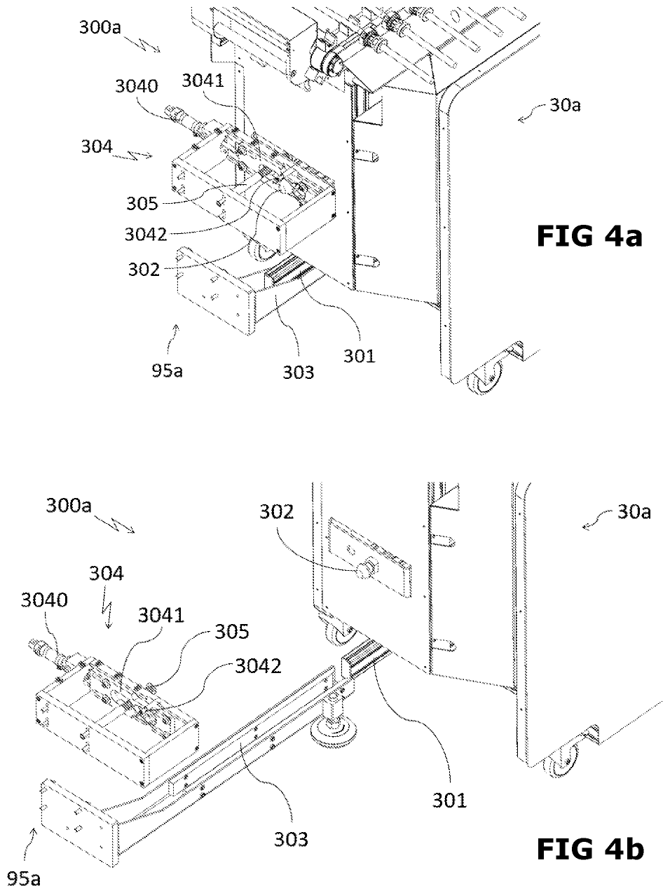

As described in FIG. 7 and FIG. 8, the cable conveying devices 320a, 320b can further be implemented as walking beams-similar to the multiple transport units 52d for the suspended transport units 53.

In the embodiment shown, the outer areas of the two cable conveying devices 320a, 320b are accessible to operators at all times. To load the machine 90, the operators place the unprocessed cables 80 or pieces of cable into the cable conveying device 320a on the input side 95a (represented by the bold block arrow in the depositing area 321a) and remove the processed cable 80 from the cable conveying device 320b on the output side 95b (represented by the thick block arrow in the removal area 321b). This can also be accomplished during operation of the machine 90, preferably not individually, but in tranches, e.g. according to a warning if a fill level of the cable conveying device 320a or 320b is exceeded or fallen below. Corresponding sensors 322, preferably designed as cameras or contactless proximity switches, are used for this fill level measurement, and/or several binary sensors (e.g. inductive sensors, capacitive proximity sensors, limit switches, light barriers, etc.) can also be provided, the arrangement of which may vary depending on the embodiment. Only the fill level sensor 322 on the input side 95a is shown here as an example. In the same way, corresponding sensors 322 can also be provided on the output side 95b.

With this mode of operation, for example, a single operator or robot can take over both the loading and the unloading and/or operate multiple machines 90. A wagon change and a standstill of the machine 90 possibly associated therewith can be dispensed with. However, cables 80 have to be added and removed regularly; in this special embodiment individually and directly at the machine 90 in each case—and not as in the other embodiments as wagon loading with several cables 80, which are also loaded or unloaded from the wagon 30a, 30b away from the machine 90 and/or further processed and/or packaged. However, manual or automated loading and/or unloading 321a, 312b from or to a wagon can also take place in this case. In the example shown, the cables 80 are transported inside the cable processing machine 90 in the same way as in FIG. 1a with the aid of the grippers 11, 20a, 20b and the associated transfer mechanisms 12, 22a, 22b from, to and between the cable processing stations 70a, 70b but can also take place according to another of the embodiments shown here.

FIG. 1c shows an embodiment which, so to speak, combines the main features and thus the advantages of the two variants shown so far. Here, too, the cable holders 32a, 32b are fastened to cable conveying devices 320a, 320b. However, unlike in FIG. 1b, these cable conveying devices 320a, 320b are part of cable transport units 30a, 30b which move independently of the cable processing machine 90 and can be docked and undocked at this, e.g. similar to the wagons in FIG. 1a.

In this embodiment, both operating modes are possible during the loading and/or unloading process, i.e. suspended complete wagons 30a, 30b (as in FIG. 1a) and/or depositing/removing individual cables 80 from the cable conveying devices 320a, 320b (as in FIG. 1b), as is symbolized by the thick block arrows 321a, 321b or those at the wagons 30a, 30b.

According to the invention, there are preferably at least two options for driving the cable conveying devices 320a, 320b: The first option is a dedicated drive for this purpose, directly on the wagon 30a, 30b, preferably connected to a dedicated controller 35 on this wagon 30a, 30b. This variant is advantageous in combination with intelligent wagons 30a, 30b (e.g. as in FIG. 1a, right) which already have a dedicated controller 35 and a power supply 354 and can also be used for drive and/or navigation outside the machine 90. If simple wagons 30a, 30b without their own controls are used, the drive 311 for the cable conveying device 320a, 320b can preferably be part of the cable processing machine 90. In particular, the drive for the cable conveying device 320a, 320b can be accomplished in a manner similar to that in FIG. 4c or FIG. 4d, in particular the block 310a, 310b shown schematically here can be formed, for example, with the individual elements shown later 311, 312a, 312b and/or 313a, 313b. The energy can be transmitted to the cable conveying device 320a, 320b electrically, but preferably purely mechanically via a mechanical coupling 310a, 310b in the area of the docking mechanism 300a, 300b. In particular, but not only after docking, a dedicated sensor or the same sensor 322 that is used for measuring the fill level, preferably embodied as camera, can be used to calibrate the positioning of the drive or the cable 80 in relation to the gripper 20a, 20b.

In one embodiment, the two coupling halves 312a, 312b and 313a, 313b can be configured, for example, as gear wheels or as a type of power take-off shaft, which are brought into engagement with one another during docking, e.g. as described in FIG. 4a and FIG. 4b.

FIG. 1d shows a system similar to FIG. 1a with two extensions which can be particularly advantageous in very long cable processing machines 90. The cable processing machine 90 consists of two or more modules, each with a frame 92a, 92b and a full frame or module-length movable transfer mechanism 12a, 12b with attached transfer gripper 11a, 11b. A further handover gripper 20c with an associated transfer drive 22c is provided for transferring the cable 80 from the first transfer gripper 11a to the second transfer gripper 11b. Due to this structure, two or more cables 80 can now be processed simultaneously in the machine 90, which improves the cycle time. In other embodiments, the cable processing machine 90 can also have three or more transfer grippers and more handover grippers and transfer drives to match. With standardized lengths for the frames 92a, 92b and the transfer mechanisms 12a, 12b attached thereto for the transfer grippers 11a, 11b a modularly configurable cable processing machine 90 can thus be provided.

In addition, an intermediate buffer store 40a with further cable holders 32c is provided on the input side 95a. This is part of the cable processing machine 90 or a module of this, and is specially configured to bridge the time of the wagon change. This is particularly advantageous when the wagon change takes longer than one processing cycle. During normal operation, the handover gripper 20a not only transfers the cables 80 removed from a cable holder 32a of the wagon 30a to the transfer gripper 11a, but also deposits some of them in a cable holder 32c of the input-side intermediate buffer store 40a—until this is full. The intermediate buffer store 40a is preferably filled in waiting times between the supplies to the transfer gripper 11a, which are preferably treated with priority. As soon as all the cables 80 have been removed from the cable holders 32a of the wagon 30a, a signal sounds for the user to change the wagon 30a or this is changed automatically. During the wagon change, the cables 80 temporarily stored in the intermediate buffer store 40a are transferred to the transfer gripper 11a. Thus, the cable processing machine 90 can continue to run undisturbed. With a sufficiently high storage capacity of the intermediate buffer store 40a, which is in particular matched to the duration of the wagon change, uninterrupted operation can thus take place.

A similar intermediate buffer store 40b with the associated cable holders 32d can alternatively or additionally also be provided on the output side 95b—in a similar or converse manner.

To monitor the current fill level in the intermediate buffer stores 40a, 40b, either all the depositing and removal processes can be stored in the control program, and/or additional sensors can be used (not shown), preferably one per cable holder 32c, 32d and/or a camera system, which, for example, can be attached at the handover grippers 20a, 20b.

FIG. 1e shows an expanded embodiment of an overall system for processing long, pre-cut pieces of cable, which are wound into a cable coil 80c with at least one, preferably several, loops or turns in a space-saving manner. In addition to the cable transport device 10 for transporting the cable end areas 82, a suspended or coil transport device 50 is provided here with elements configured accordingly for this purpose in the cable processing machine 90 and in the two cable transport units 30a, 30b. At least one of the cable end regions 82 of the cable coil 80c is deposited in the cable holders 32a, 32b or held by the grippers 11, 20a, 20b during its infeed and/or outfeed. The cable coils 80c are transported with the aid of suspended transport units 53 which, for example, are guided in the guides 51a, 51b, 51c and are actively moved by the transport devices 52a, 52b, 52c, or optionally can also be entrained by the gripper movements. Each suspended transport device 53 has a coil or suspended fastening 55, implemented here as a hook, in which the respective cable coil 80c is suspended. The suspended fastening 55 can preferably be rotatably mounted in its suspended transport unit 53, for example with the aid of the rotatable mounting 54 shown. The middle guide 51c in the example shown here is connected to the cable processing machine 90, the two outer guides 51a and 51b are connected to the respective cable transport units 30a, 30b. The transport devices 52a, 52b, 52c for the suspended transport units 53 are part of the cable processing machine 90 and are connected to its controller 93. In the embodiment shown as an example, they each have a linear drive axle with a guide and a driver part that can be retracted and extended to match mating surfaces in the suspended transport units 53. They are arranged offset to one another and overlapping, so that when a suspended transport unit 53 is transferred from one transport device 52a to the next 52c, there is always at least a one-sided form fit between at least one transport device 52a, 52b, 52c and the suspended transport unit 53. The movements of the transport devices 52a, 52b, 52c are preferably largely synchronous with the movement of the transfer gripper 11 and/or the handover gripper 20a, 20b or the associated transfer mechanisms 12, 22a, 22b. This ensures that the cable end areas 82 and the associated cable coils 80c move almost synchronously and cannot get caught in an adjacent cable coil 30c.

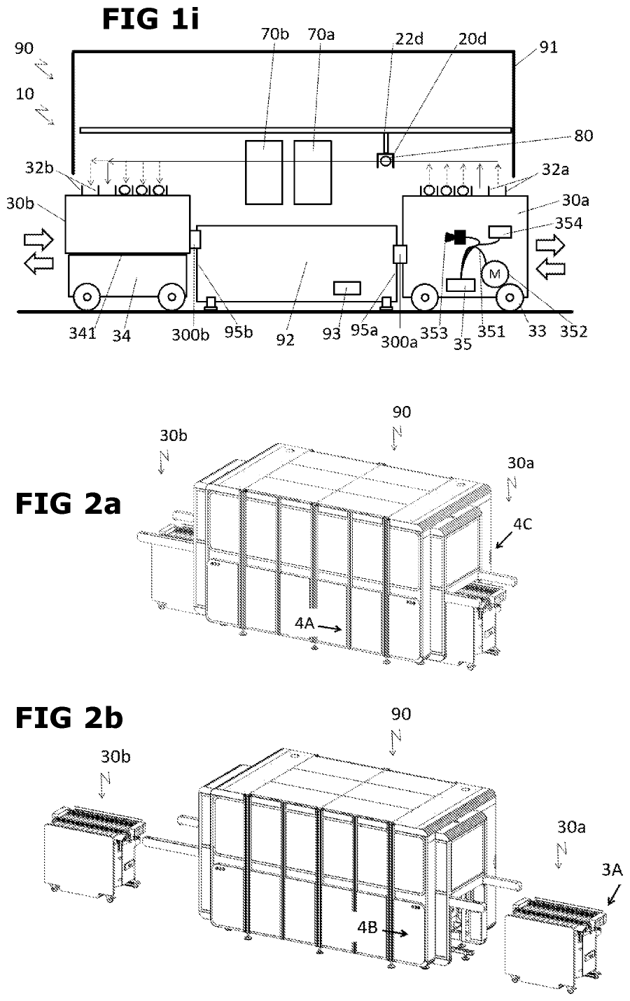

In order to further improve the reliable replenishment of cable coils 80c from the loading wagon 30a, a special multiple transport device 52d can be provided there, also known as a “cable conveying device”. In contrast to the simple transport devices 52a, 52b, 52c, all the suspended transport units 53 are moved or conveyed simultaneously on the guide rail 51a, similar to the cables 80 in the cable conveying devices 320a, 320b. This multiple transport unit 52d can also be configured as a conveyor belt, conveyor chain or walking beam. The design as a walking beam is particularly advantageous here. Exemplary embodiments of such walking beams and their mode of operation are described in FIG. 6, FIGS. 7a-e and FIGS. 8a-f. All the transport units 52a, 52b, 52c, 52d are part of the cable processing machine 90. Alternatively, at least some of them can also be attached to the wagons 30a, 30b—like the associated guide rails 51a, 51b. Another multiple transport device can also be installed in the unloading wagon 30b. The attachment of the cable holders 32a, 32b to cable conveying devices 320a, 320b as part of the wagons 30a, 30b (e.g. as in FIG. 1c) is a further embodiment here.

In order to achieve the reliable replenishment of cable coils 80c in the loading wagon 30a completely without its own drive, there are also other embodiments according to the invention. One of them is executed with a passive force element, preferably implemented as a constant force spring, which pushes the rearmost suspended transport unit 53 in the direction of the cable processing machine and thus also pushes all the others along with it, similar to cartridges in the magazine of a gun.

In one embodiment, for example, the travel range of the input-side transport device 52a can be extended into the area of the loading wagon 30a, and this is preferably equipped with at least one additional sensor and/or a corresponding mechanism in order to move the next suspended transport unit 53 there-even if their position is not precisely defined and is slightly different each time. In a further embodiment, the multiple transport unit 52d can be part of the wagon 30a and mechanically coupled to the cable conveying device 320a for transport of the cable end regions 82, the drive of which can in turn be part of the cable processing machine 90, for example with a coupling 310a as shown in FIG. 1c, FIG. 4c, or FIG. 4d.

The housing 91 is preferably designed such that it does not impede the retraction and extension of the wagons 30a, 30b with the guide rails 51a, 51b attached thereto and the cable coils 80c suspended thereon and nevertheless still protects the user from all dangerous movements of the cable processing machine 90, in particular also the multiple transport device 52d.

FIG. 1f shows an alternative embodiment according to the invention of a loading device 60a for the input side 95a, with a very high storage capacity and only a small space requirement, which can preferably be used for very short cables 80. A cable conveying device 320a is again used here-either as here (and for example, in FIG. 1b) depicted as part of the cable processing machine 90, or as part of an external cable transport unit 30a, as, for example, in FIG. 1c. Above the cable conveying device 320a a fastening is provided on which several magazines 61a, 61b, 61c can be arranged vertically one above the other. These magazines 61a, 61b, 61c are used to accommodate a plurality of cables 80 and have an actuatable underside 62a, which can adopt two states. In the unactuated state (shown with the magazines 61b, 61c), this underside is closed, as a result of which all cables 80 remain lying therein. When actuated (shown at magazine 61a), the underside 62a is opened, causing all of the cables 80 to drop into the cable conveying device 320a below. The actuating device 63a, which is preferably connected to the control 93 of the cable processing machine 90, is provided for actuating the individual magazines 61a, 61b, 61c or their underside. In the example shown, this consists of a vertical drive axis for moving the respective magazine 61a, 61b, 61c and a ram for actuating the underside. As a result of at least one sensor in the area of the cable conveying device 320a (not shown)—or based on the distance or number of movements of the cable conveying device—the controller 93 knows when the cable conveying device is empty and starts a sub-program for refilling. For this purpose, the lowest magazine 61a is first actuated, as a result of which the cables 80 lying therein fall into the cable conveying device 320a. After that, all the magazines 61b, 61c located above are actuated one after the other, so that the cables 80 always fall one level lower. This ensures that the lowest magazine 61a is always full and the upper magazines 61bc are emptied one after the other. By counting the cables 30 and/or additional sensors in the area of the magazines (not shown), the controller 93 knows at all times how many cables 80 are still in stock and can give the user a warning signal in good time when it is necessary to replace the empty magazines 61a, 61b, 61c for new full ones or refill the magazines 61a, 61b, 61c. Magazine transport devices 64a can be used to transport the magazines, shown schematically by two block arrows. These are advantageously designed as wagons or trolleys, with similar features as already described for the wagons 30a, 30b. In an alternative embodiment, at least part of the magazines 61a, 61b, 61c can be attached to the machine 90. Optionally, automatic refilling can also take place, for example with an autonomous transport system and/or robots.

A similar device with a plurality of stacked, actuatable magazines 61d, 61e, 61f can also be used as an unloading device 60b on the output side 95b. Here, the magazines 61d, 61e, 61f are arranged where in the other embodiments (e.g. FIG. 1a to FIG. 1e) the cable holders 32b of the unloading wagon 30b and/or the cable conveying device 320b are provided. The cables 80 are placed in the correct place of the uppermost magazine 61d directly by the left handover gripper 20b. As soon as this magazine 61d is full, the cables 80 located therein are passed on to the respective lower magazines 61f with the aid of the actuating device 63b. Here also, a magazine transport device 64b is preferably used for transporting the magazines 61d, 61e, 61f.

Also shown—but independently of the use of actuatable magazines 61a, 61b, 61c, 61d, 61e, 61 on the input side 95a or output side 95a—at least one further magazine 65 is provided on the output side 95b as a defective parts magazine or scrap box for defectively produced cables 80f or bad parts. For this purpose, the travel path of the left handover gripper 20b is extended in such a manner that all locations of this additional magazine 65 can also be approached. The additional magazine 65 for the defectively produced cables 80f can naturally also be used in all other embodiments of the output side 95b—e.g. in FIG. 1a to FIG. 1i. The defectively produced cables 80f are preferably marked and/or rendered unusable, e.g. by an additional cut in a bad part cutting station (not shown) provided for this purpose, in order to rule out confusion with cables 80 that have been produced correctly.

In addition to being deposited in individual magazine compartments, the defectively produced cables 80f can also all be ejected into a common reject box.

FIG. 1g shows an expanded overall system according to the invention, similar to that in FIG. 1b, in which loading and/or unloading takes place fully automatically. For this purpose, the system is expanded by the automatic loading device 400a in the depositing area 321a and the automatic unloading device 400b in the unloading area 321b.

In the example shown, the automatic loading device 400a consists of at least one gripper 4020, a transfer mechanism 4022 that moves it, and a dedicated controller 4093. This gripper 4020 is also referred to as an external gripper 420 for differentiation. A loading wagon 430a with cable holders 432a fastened to it and cables 80 located therein can be positioned in the area of this loading device 400a. This loading wagon 430a can be designed similarly to the transport wagons 30a, 30b described in FIG. 1a and optionally equipped with a docking mechanism (not shown) for exact positioning at the cable processing machine 90, preferably for a mechanical positioning but alternatively also for a virtual positioning with a contactless position detection via sensors. A camera 4322 is preferably used to monitor the fill level. Optionally, a dedicated housing 4091 for the loading and/or unloading device 400a, 400b can also be provided. The complete loading device 400a can in particular be configured in such a manner that it can be attached to the cable processing machine 90 and also removed again as quickly and easily as possible in order to switch between manual individual loading (as in FIG. 1b) and fully automatic wagon loading. In addition to a complete removal, alternatively e.g. also by means of an opening or removal of the housing 4091, the gripper 4020 with the transfer mechanism 4022 can be brought into a parking position and deactivated together with it, and the depositing area 321a can be made accessible for manual operation.

In fully automatic operation, the cables 80 are successively transported from the cable holders 432a of the loading wagon 430a into the cable holders 32a of the input-side cable conveying device 320b, by means of the gripper 4020 and the transfer mechanism 4022. The image of the camera 4322 supports this. With sufficient number of degrees of freedom in the transfer mechanism 4022 and corresponding intelligence of the control software for interpreting the camera image, a positionally accurate docking of the wagon and thus a docking mechanism can be dispensed with here. For this purpose, the transfer mechanism 4022 can be implemented completely or in part using a standard articulated-arm industrial robot. All the drive axles of the transfer mechanism 4022 and the gripper 4020 are preferably configured with force measuring systems, additional sensors and software, which are trained and certified for collaborative operation together with humans. In this embodiment, there is no need for a housing 4091 for the automatic loading device 400a—as shown on the left-hand side for the unloading device 400b and the associated unloading wagon 430b. These elements are constructed similarly or identically to those just described.

FIG. 1h shows another possibility for providing the two operating modes of individual loading (similar to FIG. 1b) and reloading of complete wagon loads of cables 80 (similar to FIG. 1a). For this purpose, the two cable conveying devices 320a, 320b are designed with chains 3205a, 3205b instead of belts, the chain segments 3206 of which can be easily opened and closed or connected and separated by the operator, preferably without tools or similarly to an energy chain/drag chain (e.g. from Kabelschlepp or Igus), ideally even automated by the cable processing machine 90. The drive 3111a, 3111b is configured here in such a manner that it can convey the chain 3205a, 3205b and the cable holders 32a attached thereto with cables 80 fixed therein even when the chain 3205a, 3205b is not tensioned-similar to, for example, feed drives for crimp contacts or other consumables attached to belts/chains in cable processing stations 70. For this purpose—as shown on the input side 95a-a suitable mating surface 3112a can be provided directly opposite the drive wheel 3111a, which ensures the permanent positive connection between the chain 3205a and the drive wheel 3111a. This simple design is sufficient and appropriate on the input side 95a, which only needs to be pulled. Alternatively and particularly expediently, on the exit side 95b—where the chain 3205b loaded with cables 80 is mainly pushed—there is a special drive 3111b, in which instead of the drive wheel 3111a with teeth, a drive belt with internal and external teeth is used, and a matching straight mating surface 3112b. A drive of this type or of a functionally similar design offers the advantage that it can be used in the linear part of the conveyor section and can therefore be placed at a location where the majority of the chain is still predominantly pulled instead of pushed, which makes it more reliable. Alternatively (not shown), a simple drive can also be installed on the output side 95b, identically to the input side 95a, and the chain 3205b can run in a guide, which prevents an undesired buckling of the chain links when pushed.

For loading with a complete wagon load, an open piece of a chain 3205c can be placed on a transport wagon 34a and equipped with cables 80—which can also be accomplished remotely from the cable processing machine 90. This transport wagon 34a is brought into the area of the entrance side 95a and a user or the machine connects the chain 3205c on the transport wagon 34a with the chain 3205a in the cable conveying device 320a—represented by the arrow between the chain segments 3206 at the respective ends of the chain 3205a on the machine and the chain 3205c on the transport wagon 34a.

The thus lengthened or assembled chain now enables the processing of all cables 80 which have been transported on the transport wagon 34a. When suspended wagons, the machine does not have to be stopped—as for example in FIG. 1c—since a part of the chain 3205a remains on the machine and provides a supply of cable for a change duration of the transport wagon 34a. There is also no restriction to short cables, as in the case of loading the magazine in FIG. 1f. Complex handover grippers with the associated transfer systems as shown in FIG. 1g can thus also be dispensed with. In such an embodiment with separable chains 3205a, 3205b, 3205c, connection and release of the chain segments 3206 as well as refilling and emptying of the areas under the cable conveying devices 320a, 320b can be carried out in a simple manner, preferably manually by a user and/or optionally at least partially automated.

The output side 95b can be configured in a functionally similar manner—but correspondingly in the reverse sequence. Here the chain 3205b is not assembled by the user, but pieces of suitable length are cut e.g. corresponding to the length of a transport wagon 34b—shown here by the arrow with the scissors symbol. With a corresponding configuration of the separating and connecting mechanism in the chain segments 3206, automatic separating can also be carried out using drives of the cable processing machine 90 (not shown). The transport wagons 34a, 34b can be configured very simply in a minimal configuration; a planar support surface and wheels are sufficient, optionally with rails or guides for the chain 3205b. Also a precise docking relative to the cable processing machine 90 can be dispensed with in simple designs, only a device should prevent at least the output-side transport wagon 34b from being pushed away by the chain 3205b, for example with a foot-operated parking brake on one of the rollers, by hooking onto the machine, etc. (neither of which is shown).

For the handling of the empty chain segments 3206, preferably chain supply collection devices 329a, 329b are provided below the cable conveying devices 320a, 320b, preferably designed as a box 329a on the input side and preferably as a roller 329b on the output side. Their fill level can be monitored by corresponding sensors 322b (only shown here as an example on the outlet side 95b). In addition to these fill level sensors 322b and the cable fill level sensor 322, another sensor 322a is preferably also provided on the input side 95a, which detects the end of an open chain 3205a and in this case generates a reloading and/or stop signal.

Alternatively to the two chain supply collection devices 329a, 329b on both sides, the chains 3205a, 3205b can also be connected to one another on both sides such that the empty chain links 3206 are conveyed from the input-side cable conveying device 320a to the output-side cable conveying device 320b.

If the chain segments 3206 are configured such that they also enable mechanical opening, the empty chain pieces can also be placed on the input-side chain supply collection device 329a, already prepared to the lengths suitable for the wagons 30a, 30b. The chain links 3206, which have been emptied and prepared to a suitable length, can also be directly deposited again in the lower wagon area on the transport wagon 34a on the input side (instead of in a chain supply collection device 329a). Similarly, a supply of empty chain links 3206 on the output side can also be taken from a lower portion of the transport wagon 34b (rather than from a chain supply collection device 329b). In both cases, a manual or automatic connection and separation of the chain takes place during a wagon change at the appropriate point (e.g. below and/above). Thus, both new and used chain links can be supplied and removed when the wagon is changed.

For a better fixing of the cables 80, the chains 3205a, 3205b are preferably designed to be so wide that several cable holders 32a per cable 80 can be attached to them, and/or several chains run parallel (similar to the belts 3203, 3204 in FIG. 3a). It can also be advantageous to equip only those chain links or chain segments 3206 (or only the respectively correct side there) with the mechanism for particularly easy opening and closing of the chain connection-preferably as multi-link chain parts whose length matches the wagon. Thus, not only can production costs be saved, but the user is also prevented from creating “unsuitable” lengths that do not match the length of the transport wagons 34a, 34b. As already mentioned, such a mechanism can be configured such that, in addition to or as an alternative to manual opening and closing, it also enables automated opening and closing. In embodiments with automated chain separation/connection, fully automatic operation, e.g. with automatic wagon change and/or autonomously driving wagons, can also be implemented.

In one embodiment, a cable conveying device 320a, 320b according to the automatic conveyor system just described with chains 3205a, 3205b can easily be configured to be convertible to a “simple” operating mode for loading and/or unloading individual cables 80—similarly as in FIG. 1b for example. This can be accomplished, for example, whereby the cable conveying device 320a, 320b is configured in such a manner that the chain 3205a, 3205b can be provided both as a broken chain with open ends as described above and also joined together to form a closed chain, specially configured with corresponding guides or paths (not shown) for the respective chain configuration which can be used and rearranged or converted as desired. For example, the chains 3205a, 3205b can then be joined together, preferably manually, to form a closed loop or a loop—as optionally shown by the dashed arrows, with the result that the cable conveying device is reconfigured into a continuously circulating multiple-store device which can be individually loaded or unloaded with cables 80 similar to that shown in FIG. 1b.

FIG. 1i shows a simplified design similar to FIG. 1a. Here the entire cable transport is realized by a single gripper, the transfer and handover gripper 20d. A single transfer drive 22d belonging to the gripper 20d and thus the working area of gripper 20d extends over the entire machine 90. The machine 90 is thus configured for transfer-free cable transport by means of the single gripper 20d from a multiple-store device 32a on the input side, through the cable processing stations 70a, 70b and to a second multiple-store device 32b on the output side.

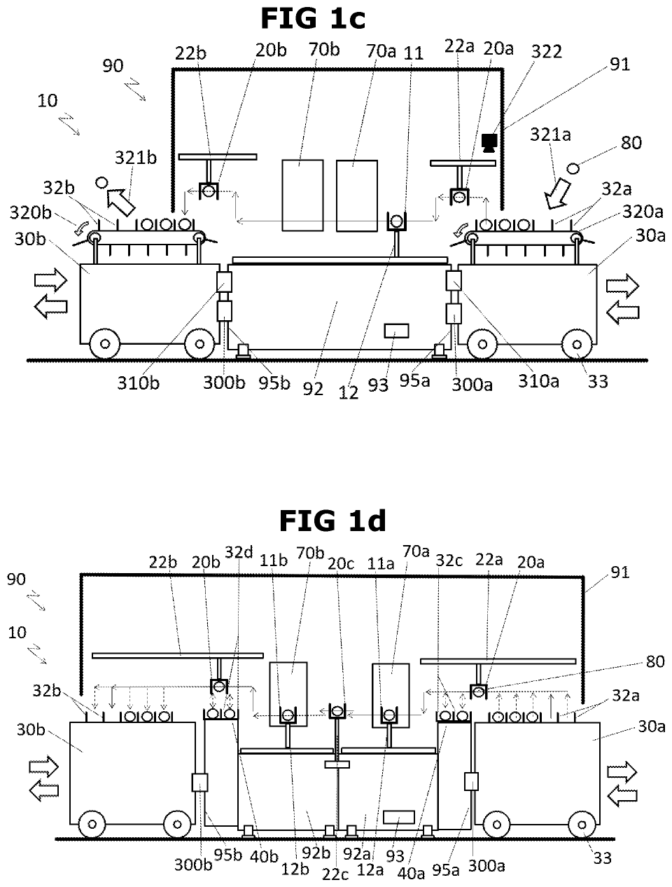

FIG. 2a and FIG. 2b show an isometric view of the embodiment such as in FIG. 1c. In FIG. 2a, once with both cable transport units 30a, 30b docked at the cable processing machine 90 and once detached in FIG. 2b. Also shown in FIG. 2a are the viewing directions for FIGS. 4a and 4c and in FIG. 2b the viewing directions for FIGS. 3a and 4b—represented by the arrows 3A, 4A, 4B and 4C.

FIG. 3a shows a detailed view of FIG. 2a, according to the arrow 3A depicted there, with some elements hidden for a better view of the cable holders 32a and the cable conveying device 320a, which moves them, configured here as a conveyor belt. In the example shown, each cable holder 32a comprises a clamp 323 and a support 324. The conveyor belt 320a consists of two belts or toothed belts 3203, 3204 which are driven via a common shaft 327. There is also a common shaft (not visible) on the opposite side in the area of docking mechanism 300a (see also FIG. 4a) and coupling 310a (see also FIG. 4c). In order to make the two cable conveying devices 320a, 320b identical for the input side and the output side, gear wheels are preferably attached to both shafts.

The clamp 323 is attached to the belt 3203 and the support is attached to the other belt 3204. The cables 80 (only one of them is shown here) are each fastened in a clamp 323 and the associated support 324, with the cable end to be processed in the area of the clamp 323. On the opposite side in the area of the support 324, even with longer cables 80, a guide 323 is provided in order to prevent adjacent cables from getting caught and thus snagging, here implemented as a plate with a smooth support surface. Alternatively, a version with several rollers can also be used.

Alternatively, supports 324 on both sides can also be used for very short cables 80 in order to simplify the deposition of the cables, which is advantageous when the conveyor belt 320a is loaded fully automatically—e.g. with a magazine loading device 60 from FIG. 1f. Clamps 323 can also be used on both sides. Instead of (toothed) belts 3203, 3204, chains 3205a, 3205b, 3205c can also be used, preferably with easily divisible chain segments 3206 and a drive 3111 that also works without chain tension, e.g. as explained in FIG. 1h. Instead of two belts 3203, 3204 or chains 3205a, 3205b, 3205c, one wide belt or one wide chain can also be used, or also three or more or a single correspondingly wide conveyor belt. If, in one embodiment, instead of clamps 323, only supports 324 are used (e.g. for very short cables), it would also be possible to use a walking beam drive for cable conveying, e.g. similar to that used for the multiple transport device 52d for the suspended transport units 53 as described in FIG. 7 and FIG. 8.

FIG. 3b shows a detailed view of FIG. 3a, with a section according to the sectional plane 3B depicted there, through the belt 3203 and the guide elements 3201, 3202a, 3202b provided for it, here executed with a plate 3201 and two sheets 3202a, 3202b. The cable clamps 323 are attached to the belt 3203. These consist, for example, of two clamping jaws 3233a, 3233b, two holders 3232a, 3232b and a receptacle 3231. The two clamping jaws 3233a, 3233b are made of elastic material and are attached to the two holders 3232a, 3232b, which are fixed here in a C-profile of the receptacle 3231. They form an “M”, similar to the “golden arches” of the McDonalds logo, which is why these clamps are also known colloquially as “McDonalds clamps” and are also known in a similar form from tool clamp strips, for example. In the embodiment shown, by moving the holders 3232a, 3232b in the C-profile, the pre-tensioning force of the clamping jaws can be adjusted to suit the type and diameter of the cable 80. The receptacle 3231 and thus the cable clamp 323 is fixed to the belt 3203 by two screws, which are arranged transversely to its conveying direction. This allows the cable clamps 323 to move smoothly around the curve at the shaft 327 (see also FIG. 3a). The attachment of the supports 324 to the belt 3204 (see also FIG. 3a) and also the guidance of this belt 3204 takes place in a similar manner.

FIG. 4a to FIG. 4d show various sectional and detailed views of FIG. 2, viewed in the direction of arrows 4A, 4C in FIG. 2a, arrow 4B in FIG. 2b and arrow 3D in FIG. 3c; with some elements partially hidden to provide a better view of the input-side coupling 310a and the input-side docking mechanism 300a.

FIG. 4a and FIG. 4b show the input-side docking mechanism 300a. In FIG. 4a in the state “brought together and locked”—as in FIG. 2a. In FIG. 4b in the “spread apart” state—as in FIG. 2b. The viewing direction corresponds to the two arrows 4A, 4B, which are shown in FIG. 2a and FIG. 2b.

In the example of an embodiment shown, a locking pin 302 and a guide 301, implemented here as a rectangular profile, is located on the wagon 30a. Located on the input side 95a of the cable processing machine 90 are the matching counterparts—the locking device 304 and the guide 304, implemented here as a U-profile. The two parts of the guide 303, 304 are pushed into one another during docking, and thus the wagon 30a is mechanically positioned or centred exactly in relation to the cable processing machine 90. In order to compensate for inaccuracies at the beginning, generous run-in areas are provided on both sides of the guide 303, 304. In order to increase the ease of use and to avoid damage, a damper 305 can also be provided, implemented here as a shaft with a spring-loaded disk and attached to the cable processing machine 90. If the wagon 30a is correctly positioned relative to the cable processing machine 90, this is detected by a sensor 3042 and the locking device 304 is activated. In the example shown, this consists of a sliding plate 3041 and a drive 3040, implemented here as a pneumatic cylinder. This sliding plate 3041 is moved by the drive 3040 for locking. As a result, their effective surfaces move into a groove in the locking pin 302 and thus produce a positive connection which fixes the wagon 30a on the cable processing machine. To release this fixing, the sliding plate 3041 moves out again. Precisely the same mechanism is installed again on the output side 95b.

In another embodiment, the locking pin 302 and the damper 305 can also both be fastened on the wagon 30a, 30b or both on the cable processing machine 90. If they are both on the same side, they can also be configured as a common functional element (not shown).

In other words, in a partial aspect of the present invention, a cable transport wagon 30a or a coupling attachment for one is provided, which is configured with a

docking mechanism 300a, which comprise: a guide element, preferably configured as an extension with substantially parallel side surfaces, a preferably rotationally symmetrical locking pin 302 with a preferably wedge-shaped

run-in geometry (chamfering) at its free end and a groove or diameter reduction (groove) behind the free end. Respectively, a cable processing machine 90 or a functional module is provided for such, which is configured with a docking mechanism 300a, which has: a tapering run-in area for side surfaces of a guide element of a wagon, at least one preferably circular opening for a locking pin 302 of the wagon with a locking unit 304 behind the opening which is configured to hold the locking pin 302 in a form-fitting manner in a locking position and to release it in an open position, and with a ramp surface for a damping element of the wagon, the locking unit preferably being configured in such a manner that an inserted locking pin 302 is automatically locked and an unlocking device that can be actuated in a controlled manner, optionally with a sensor for detecting a docked wagon. In addition to the above preferred embodiment, the person skilled in the art is also familiar with functionally equivalent embodiments of such a docking mechanism for positioning and preferably also locking docking of wagons in various variations, for example with electromagnets or switching magnets.

FIG. 4c shows a further detailed view of FIG. 2a with the viewing direction according to the arrow 4D depicted there and some elements hidden for a better view of the coupling 310a. In the embodiment shown as an example, this coupling 310a is configured with a power transmission from the cable processing machine 90 to the multiple-store device 30a, 30b. This is designed as a group of several gear wheels 312a, 312b, 313a, 313b. The drive 311 is designed as an electric motor with a transmission. It is attached to the cable processing machine 90 and has the first gear wheel 312a flange-mounted to its shaft. The second gear wheel 312b is rotatably mounted in the intermediate wheel holder 315, which in turn can rotate about the main axis of the drive 311 and is pre-tensioned by a passive force element 314. Depending on the cable conveying direction, also one or more gear wheels 12a, 312b are also located on the wagon 30a, one of which is connected to the conveyor belt 320a. As soon as the wagon 30a docks at the cable processing machine 90, the second gear wheel 312b comes into operative connection with the gear wheel 313a or the gear wheel 313b.

In order to enable engagement at any time, i.e. even if the gear wheels 312b, 313a, 313b are in an unfavourable position relative to one another—i.e. “tooth on tooth”—the gear wheel 312b can be bounced away a little by rotating the intermediate wheel holder 315 and is soon brought back into the starting position by the passive force element 314. The entire transmission is configured here in such a manner that the drive torque in the preferred conveying direction points in the same direction as the direction of action of the passive force element 314. In the case of the input side 95a shown here, the cable conveying device 320a conveys to the right, i.e. into the cable processing machine 90. The gear wheels 313a, 312b rotate clockwise, the gear wheels 313b, 312a anticlockwise. Thus, the drive torque assists the gear wheel 312b to move in the direction of the gear wheel 313b and thus in the direction of the latching position.

On the output side 95b (not shown), the conveying direction is the other way around, i.e. out of the cable processing machine 90. Therefore, no intermediate gear wheel 313b should preferably be installed on the wagon side but the gear wheel 312b should come into operative connection directly with the gear wheel 312a.

FIG. 4d shows a sectional view of the main elements from FIG. 3c, according to the sectional plane shown there using the pair of arrows 4D. There it can again be seen how the gear wheels 312a, 312b and the intermediate wheel holder 315 are rotatably mounted relative to one another and to the drive 311.

Optionally-preferably coupled with elements of the docking mechanism 300a, 300b, for example with the locking device 304 or the sensor 3042 (FIG. 3a, FIG. 3b)—the gear wheel or the cable conveying device 320a, 320b can also be fixed so that the cable conveying device 320a, 320b is blocked when the wagon is undocked and cannot be moved unintentionally. Optionally, in addition to or alternatively to the camera or sensor 322 (FIG. 1b), a position monitoring can also be provided on the cable conveying device 320a, 320b and/or the cable processing machine 90, which is configured to determine a position of the cable conveying device 320a, 320b and thus of the cable 80 located therein, so that the cables 80 can always be gripped correctly, or the cables 80 are always provided in a known position relative to the cable processing machine 90, regardless of how the gear wheels mesh (e.g. with tooth on tooth or another displacement).

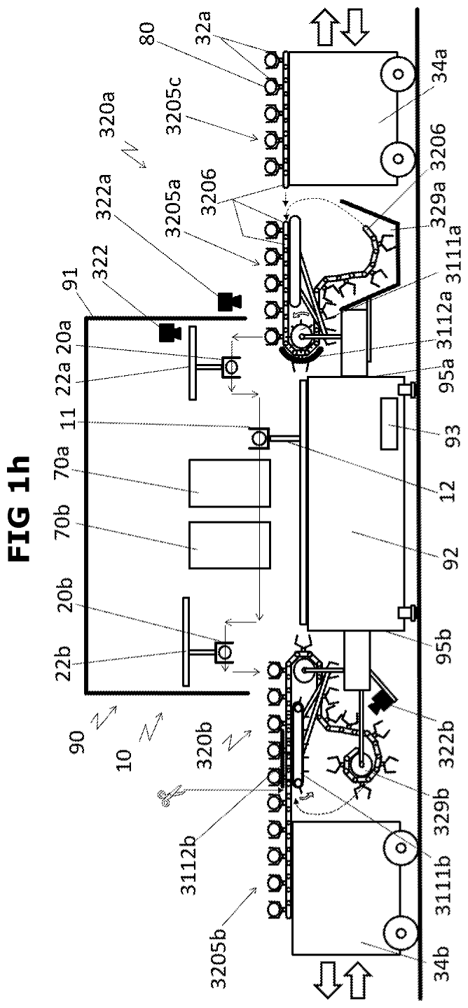

Figure Sa and FIG. 5b show special embodiments of the cable transport unit 30a for the transport of coiled cables 80c, similar to that shown schematically in FIG. 1a. All cable coils 80c are suspended in each case in a suspended transport unit 53, which are guided in the guide rail 51a. The cable ends to be processed are each clamped in a cable clamp 323 and guided over a support 324 in the direction of the cable coil 80c—identically as with shorter, non-coiled cables 80 as in FIG. 3a.

FIG. 5a shows a special design of the cable transport unit 30c, which also comprises the guide rail 51a.

FIG. 5b shows a further design for the wagons for transporting the cable coils 80c. Here, the guide rail 51a for the suspended transport units 53 is attached to a separate suspended transporter or extra wagon 30e, which can be moved independently of the main wagon 30a. This main wagon 30a is preferably designed identically to the wagons 30a, 30b already used for shorter cables 80, e.g. as shown in FIG. 2 to FIG. 4. For the correct positioning of the extra wagon 30e, another docking mechanism similar to 300a, 300b (not shown) can be provided-either between the two wagons 30a, 30e or between the extra wagon 30a and the cable processing machine 90. In addition to the low variety and complexity of the wagons, the design with two separate wagons 30a, 30e also enables the “reload individually” operating mode to be simplified. In this case, the main wagon 30a always remains docked, the user drives the cable coils 30c close with the extra wagon 30e and places the cable ends of the cable coils 80c individually in the cable clamps 323. Similar wagons can be used on the unloading side as on the loading side.

Also shown are two basic possibilities as to how the cable coil 80c can preferably be suspended. In FIG. 5a, the rear outlet of the cable coil 80c, facing away from the cable clamp 323, is clamped and processed; in FIG. 5b the front outlet facing the cable clamp 323 is processed. When using the rear outlet as in FIG. 5a, the cable 80 can be rotated more easily and with less torque for correct alignment for subsequent processing. On the other hand, the length of the unfixed cable between clamp 323 and cable coil 80c is longer, which can result in neighbouring cables or cable coils 80c getting caught. Depending on the type of cable and thus its torsional and bending stiffness, the user can freely choose which type of suspension he prefers. A swivel joint 54 (shown in FIG. 1e) is provided at least in each suspended transport unit 53 to support simple cable rotation.

FIG. 6 shows an isometric view of a cable coil conveying device or multiple transport device 52d for several suspended transport units 53, implemented here with a walking beam drive. The multiple transport device 52d comprises a plurality of drivers 521, arranged at a distance from the suspended transport units 53 on the guide rail 51a of the wagon 30c or extra wagon 30e, e.g. as in FIG. 5a, FIG. 5b These drivers 521 are configured so that they can transmit a force to the suspended transport units 53 in a positive manner. In contrast to a conveyor belt (similar to 320a, 320b), the drivers 521 of the walking beams do not run around for transport, but move back and forth at a pre-determined distance, whereby they entrain or convey the suspended transport units 53 in only one direction and return empty in the opposite direction. Exemplary drive variants are shown in the two following figures.

Alternatively or additionally, the cable conveying device 320a, 320b (for example in FIG. 1c) can be executed with such a walking beam drive, wherein in this case the cable 80 is then conveyed instead of the suspended transport units 53. For this purpose the entire walking beam drive can be designed to be similarly wide or 2× parallel, e.g. like the previously described variants with conveyor belts or chains.

FIG. 7a to FIG. 7e show the mode of operation of a multiple transport device 52d with the walking beam transport principle and a rotary, preferably electric, drive 525e. For this purpose, two disks 523a, 523b turn synchronously, connected via a chain or toothed belt 524. The connecting beam 522, to which the drivers 521 are attached, is fastened eccentrically to these two disks 523a, 523b. Due to the parallelogram produced in this way the rotation of the two disks 523a, 523b produces a circular movement of the connecting beam 522 without it rotating, similar to the “flying carpet” funfair ride. The length of the driver 521 and the distance between multiple transport device 52d and guide rail 51a is selected such that the form fit between the drivers 521 and suspended transport units 53 is created or broken in the areas in which the movement component of connecting beam 522 is reversed along the conveying direction, visible in sub-figures a, c and d. Thus, when the disks 523a, 523b rotate anticlockwise, the suspended transport units 53 are conveyed to the right (FIG. 7c to FIG. 7e) and during the rest of the movement (FIG. 7a to FIG. 7c), the drivers 521 are brought back to the starting point without that the suspended transport units 53 being disturbed thereby.

FIG. 8a to FIG. 8b show in an exemplary embodiment the mode of operation of a multiple transport device 52d with walking beam conveying principle and translatory, preferably pneumatic drive 525p and spring-loaded drivers 521. Here, too, the drivers 521 are fastened to the connecting beam 522. However, this is only moved back and forth in the conveying direction, preferably driven by a pneumatic cylinder 525p. In order not to convey the suspended transport units 53 back when the driver is brought back to its starting point (FIG. 8a to FIG. 8d), the drivers 521 are rotatably mounted in the connecting beam 522 and spring-loaded. As soon as they come into contact contrary to the conveying direction with the suspended transport units 53 (FIG. 8b) they fold in (FIG. 8c) and then fold out again when they have passed or when the connecting beam 522 is in the left end position (FIG. 3d). The rotatable mounting does not allow any movement in the opposite direction, which is why the suspended transport units 53 are reliably entrained in the conveying direction (FIG. 3d to FIG. 8f). The spring force in the swivel joint between the driver 521 and the connecting beam 522 is selected such that both reliable folding back is ensured (FIG. 8c to FIG. 8d) and undesired conveying in the wrong direction is prevented. For this purpose, the spring force must be selected to be lower than the static friction force between the suspended transport unit 53 and the guide rail 51a.

Alternatively to the passive suspension of the drivers 521 in the connecting beam 522, these can also be actively moved transversely to the conveying direction, preferably with another pneumatic cylinder or a pair of cylinders, which preferably moves the entire connecting beam 522 transversely. It is also conceivable to generate the transverse movement via at least one link guide.

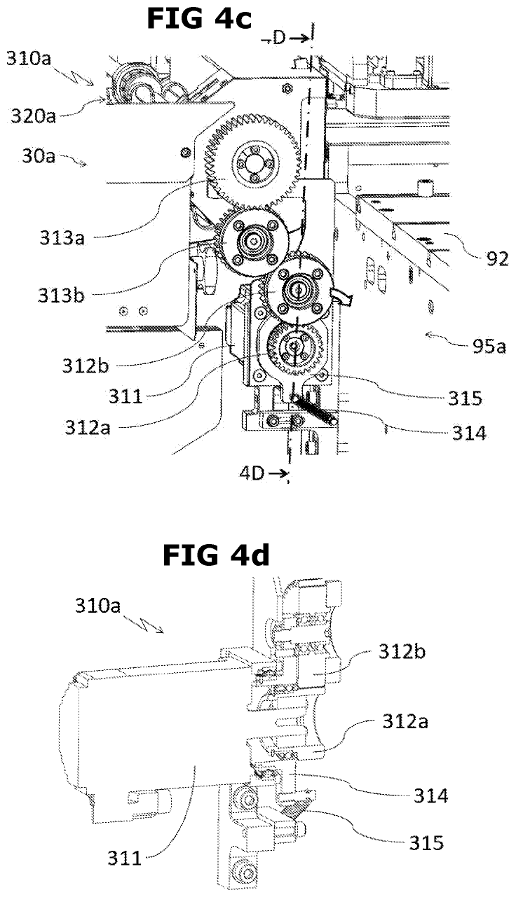

FIG. 9 shows a schematic diagram of a further embodiment of a system according to the invention as previously shown in FIG. 1a to FIG. 1i. This embodiment is structurally and functionally comparable to and applicable to the aforesaid embodiments.

In the embodiment in FIG. 9, this cable transport system 10 consists of at least one (double) transfer gripper 11c, two (double) handover grippers 20e, 20f, the transfer mechanisms 12, 22a, 22b belonging to the two grippers and two groups of cable transport units 30a, 30b for the transport of several cables 80a. These cable transport units 30a, 30b are designed as wagons or trolleys, as previously described in FIG. 1c. Otherwise, this cable transport system is structurally and functionally unchanged.

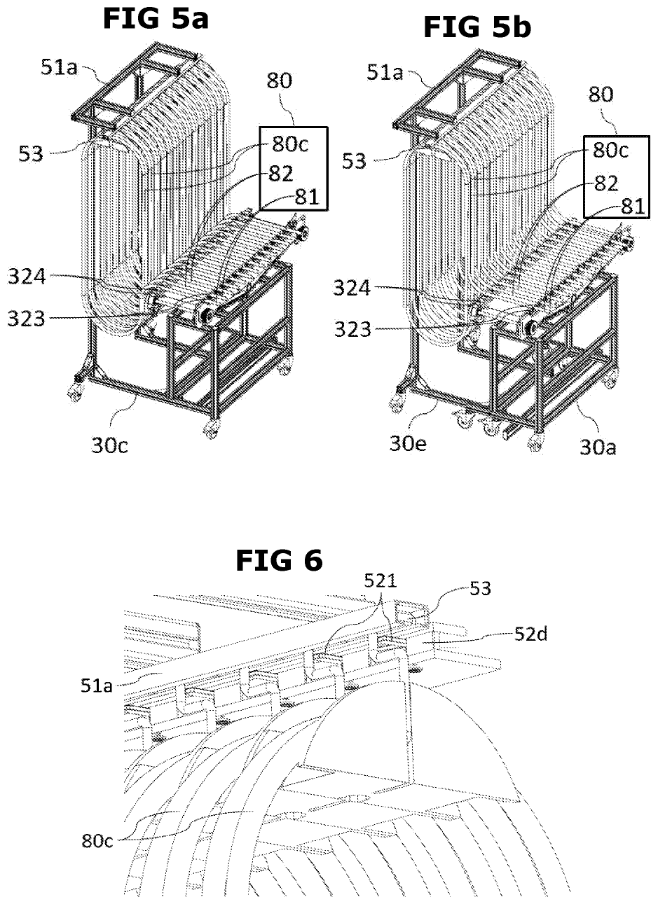

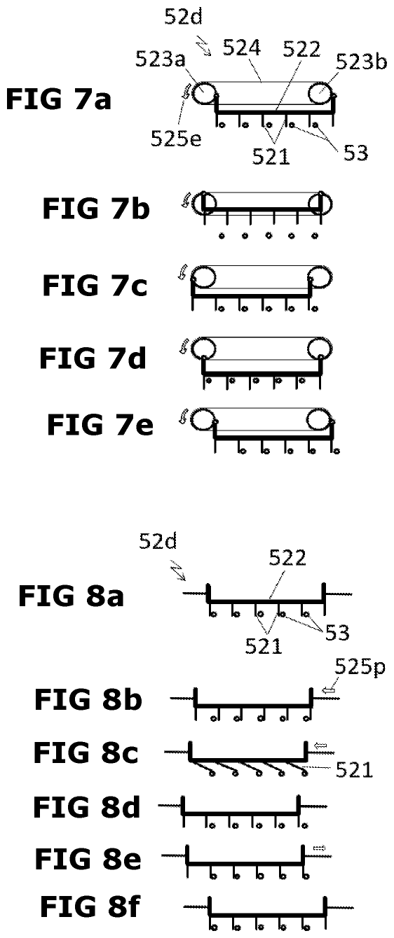

The cable 80a shown in FIG. 10 comprises at least two conductors 83a, 83b at a cable end 81a, which are spaced apart from one another. As previously described in FIG. 3a, this cable 80a can be arranged in the cable holder 32a, 32b of the multiple-store devices 30a, 30b, wherein according to FIG. 11 the two conductors 83a, 83b are each clamped in the cable clamps 323 at a distance X1 from one another and the opposite cable end 81b is arranged in a cable support 324.

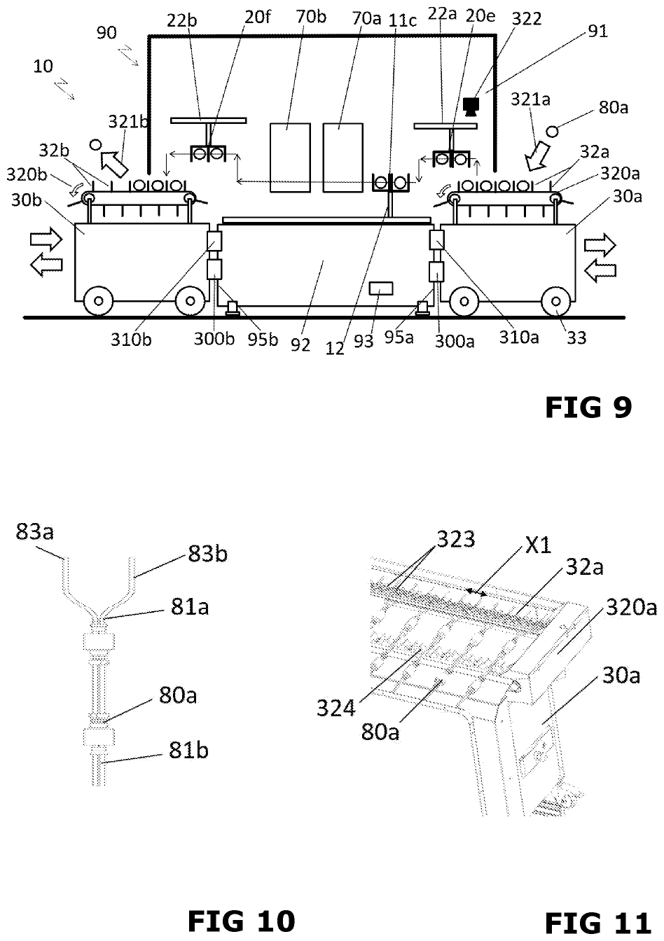

FIG. 12 shows the handover gripper 20e, which is arranged on the cable transport system 10. The handover gripper 20e is a double handover gripper and is arranged on a transfer mechanism 22a, as previously described in FIG. 1a or FIG. 1b, and is also used, for example, in the cable transport systems according to FIG. 1a or FIG. 1b. The handover gripper 20e has two pairs of gripper jaws 221a, 221b for gripping the conductors 83a, 83b. The gripper jaw pairs 221a, 221b are arranged on a gripper transfer guide 221 and are movable along the gripper transfer guide 221, so that the distance X2 with respect to each other is adjustable. For this a corresponding gripper drive device 222 is arranged on the transfer gripper 20e. On the side opposite the pairs of gripper jaws 221a, 221b, the handover gripper 20e has a receiving clamp 223, in which the cable end 81b of the cable 80a opposite the conductors 83a, 83b is arranged. During operational use, the handover gripper 20e is moved toward the multiple-store device 30a, wherein the distance X2 of the gripper jaw pairs 221a, 221b corresponds to the distance XI of the cable clamps 323 and advantageously remains unchanged.

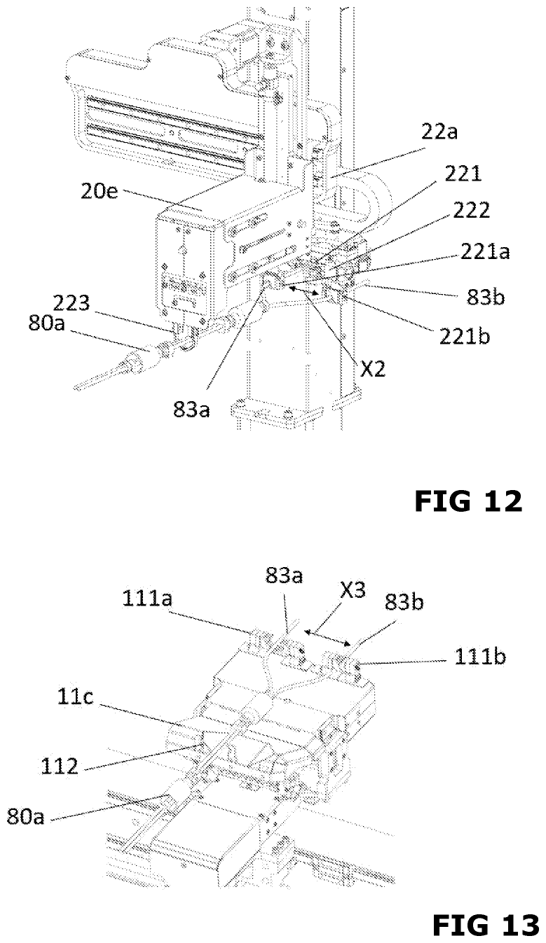

FIG. 13 shows the transfer gripper 11c, which is arranged on the cable transport system 10. The transfer gripper 11c is a double transfer gripper and is otherwise structurally and functionally the same as the transfer gripper 11a, as previously described in FIG. 1a or FIG. 1b and used for example in the cable transport systems according to FIG. 1a or FIG. 1b. The transfer gripper 11c has two pairs of gripper jaws 111a, 111b for gripping the conductors 83a, 83b, which are spaced apart by a distance X3. On the side opposite the pairs of gripper jaws 111a, 111b, the transfer gripper 11c has a receptacle 112, in which the cable end 81b of the cable 80a opposite the conductors 83a, 83b is arranged.

The handover gripper 20e transfers the removed cable 80a to the transfer gripper 11c, which feeds it to at least one, preferably at least two or more cable processing stations 70a, 70b for processing. The pair of gripper jaws 221a, 221b change their distance from X2 to X3 before or during the transfer. For this purpose, in addition to the two handover grippers 20e and transfer grippers 11c, the transfer mechanisms 12 and 22a associated with them also move, as previously shown in FIG. 1a.

As will be clear to a person skilled in the art, the embodiments and methods illustrated in the figures or described herein can also be combined and exchanged within the scope of the invention.

For example, the invention enables a cable processing system comprising a cable processing machine 90 having a machine control for the automatic processing of cable ends of heavy, rigid, pre-cut cables 80, 80a with a frame 92, 92a, 92b having (i) an input side 95a for receiving the cables 80, 80a, (ii) at least two frame-supported cable processing stations 70a, 70b, (iii) one cable transport device 10 for transporting at least one cable 80, 80a, which cable transport device 10 in the cable processing machine 90 has at least one frame-supported, movable gripper 11, 11a, 11b, 11c, 20a, 20b, 20c, 20e, 20f for the cable 80, 80a, and (iv) an output side 95b for the delivery of a processed cable 80, 80a, wherein the cable transport device 10 is equipped with a cable conveying device 320a, 320b configured as a multiple-store device 30a, 30b, which has a plurality of cable holders 32, 32a, 32b, and wherein at least the at least one gripper 20a, 20d, 20e, 20f is configured as a handover gripper, preferably using a frame-supported transfer mechanism 22a, 22d, to remove one of the cables 80, 80a after the other from the respective cable holder 32, 32a, 32b and feed it to at least one of the cable processing stations 70a, 70b and/or to a further gripper 11a, 11b, 11c, 20b, 20c, 20e, 20f, which further gripper 11, 11a, 11b, 11c, 20b, 20c, 20e, 20f is configured to be movable with a further frame-supported transfer mechanism 11, 12a, 12b, 22b, 22c in such a manner in order to transfer the cable 80, 80a in one of the cable processing stations 70a, 70h, and the multiple-store device 30a, 30b is configured as an autonomous or guided transporter 34.

As a further example, the invention provides an infeed system for heavy, rigid cables 80, 80a to a cable processing machine 90 according to the previous example for the automatic processing of cable ends of the cables 80, 80a in at least one cable processing station 70a, 70b of the cable processing machine 90, with a multiple-store device 30a, which is configured as an autonomous or guided transporter 34, which can be detachably docked to the cable processing machine 90 with a docking mechanism 300a between the transporter 34 and an input side 95a of the cable processing machine, the multiple-store device 30a having a plurality of cable holders 32a, which cable holders 32a are configured in such a manner that one of the cable ends can be removed therefrom mechanically by a cable transport device 10 of the cable processing machine 90 and fed to a plurality of cable processing stations 70a, 70b for processing the cable ends, the transporter 34 being configured in such a manner that during cable processing as long as it still contains cables 80, 80a the multiple-store device 30a remains docked on the input side 95a and the cable 80, 80a can be moved from and to the cable processing stations 70a, 70b in the cable processing machine 90 separately from the multiple-store device 30a.

According to the invention, however, the infeed system can also be used independently of the cable processing machine 90 according to the first example.

As yet another example, the invention provides a outfeed system for heavy, relatively rigid cables 80, 80a from a cable processing machine 90 according to the first example for automatically processing cable ends of cables 80, 80a in at least one cable processing station 70a, 70b of the cable processing machine 90, with a multiple-store device 30b, which is configured as an autonomous or guided transporter 34, which with the aid of a docking mechanism 300a between the transporter 34 and an output side 95b of the cable processing machine 90 can be detachably docked to the cable processing machine, wherein the multiple-store device 30b has a plurality of cable holders 32b, which cable holders 32b are configured in such a manner that one of the cable ends can be mechanically deposited in them by a cable transport device 10 of the cable processing machine 90 and can be removed from a processing of the cable ends by at least one of the cable processing stations 70a, 70b, wherein the transporter 34 is configured in such a manner that the multiple-store device 30b remains docked on the output side 95b during cable processing as long as it still has space for at least one cable 80, 80a and that the cable 80, 80a can be moved separately from the multiple-store device of the cable transport unit 30b to and from the cable processing stations 70a, 70b in the cable processing machine 90.

According to the invention, the outfeed system can also be used independently of the cable processing machine 90 according to the first example.

### REFERENCE LIST

3A-B, 4A-D Arrow (pair) for viewing direction/section definition
10 Cable transport device
11, 11a-b Transfer (gripper)
11c Transfer (gripper)
111b Pair of gripper jaws
112 Receptacle
12, 12a-b Transfer mechanism (multiple drive axles)
20a-c Handover (gripper)
20d Handover and transfer gripper
20e, 20f Handover (gripper)
211a, 211b Pair of gripper jaws
221 Gripper transfer guide
222 Gripper drive device
223 Receiving clamp
22a-d Transfer mechanism (multiple drive axles)
30a-b Multiple-store device (cable transport unit, trolley, trolley, multiple transporter)
30c Multiple-store device with rail for suspended transport units
30e Extra wagon, (cable) (multiple) suspended transport unit
300a-b Docking mechanism
301 Guide (male, profile)
302 Locking element (locking pin)
303 Guide (counterpart, female)
304 Locking device
3040 Locking drive (cylinder)
3041 Sliding plate
3042 Sensor
305 Damper
310a-b Coupling
311 Drive (for conveying device)
3111a-b (Chain) drive (wheel)
3112a-b Counter surface
312a-b Coupling half (gear wheel, drive side)
313a-b Coupling half (gear wheel, conveyor belt side)
314 Passive power element (spring)
315 Intermediate wheel holder
32a-d Cable holder (clamp, support, divider)
320a-b (Cable) conveying device (conveyor belt, walking beam)
3201 Plate (guide element)
32021-b Sheet (guide element)
3203, 3204 Belt
3205a-c Chain (with easily separable segments)
3206 Chain segment
321a Depositing area
321b Removal area
322 (Cable fill level) sensor (camera)
322, 322a-b (Chain segment) sensor (camera)
323 (Cable) clamp
3231 (Holder) receptacle
3232a-b (Clamping jaw) holder
3233a-b Clamping jaw
324 (Cable) support
327 Shaft
328 Guide
329a-b (Chain supply) collection device (box, roller)
33 Moving element (wheel)
34 Transporter (wagon)
34a-b Transport wagon
341 Mechanical interface
35 Control, (partial) autonomous driving system
351 (Control) cable
352 Drive (for self-movement)
353 Sensor (camera)
354 Power supply (battery, rechargeable battery)
40a-b Intermediate buffer storage (additional cable holder)
400a Automatic loading device
400b Automatic unloading device
4020 Handover (gripper)
4022 Transfer mechanism (robot)
4091 Housing (casing)
4093 Control
4099 Sensor (camera)
430a-b Loading or unloading wagon (transporter, wagon, trolley)
432 Cable holder (clamp, support, divider)
50 suspended transport device (coil transport device) (coil handling)
51a-c Guide, guide rail, rail
52a-c Transport device (for 53)
52d Multiple transport device (walking beam, conveying device)
521 Driver
522 Connecting beam (beam)
523a-b Disk
524 Toothed belt
525e (Rotary) drive (electric)
525p (Translational) drive (pneumatic)
53 Suspended transport unit (carriage, transport wagon)
531 Carriage (transport wagon)
54 (Rotatable) mounting
55 Suspended attachment (hook)
60a (Magazine) loading device
60b (Magazine) unloading device
61a-f (Loading/unloading) magazine
62a (Actuatable) underside
63a-b Actuating device
64a-b Magazine transport device
65 (Defective parts/bad parts) magazine (scrap box)
70a-b Cable processing station
80 Cable
80a Cable
80f (Faulty) cable (bad part, defective part)
80c1, 81c2 Cable remnant (incomplete cable coil)
81 Cable end
81a, 81b Cable end
82 Cable end area
83a, 83b Conductors
90 Cable processing machine
91 Housing (cladding)
92, 92a-b Frame (framework, module)
93 Controller
95a Input side
95b Output side
XI Distance from 83a to 83b to 32a
X2 Distance from 83a to 83b to 20e
X3 Distance from 83a to 83b on 11c

1-44. (canceled)

45. A cable processing system comprising a cable processing machine (90) with a machine controller for the automatic processing of cable ends of heavy, rigid, pre-cut cables (80, 80a) having a frame (92, 92a, 92b) and having
an input side (95a) for receiving the cables (80, 80a),
at least two frame-based cable processing stations (70a, 70b),
a cable transport device (10) for transporting at least one cable (80, 80a), which cable transport device (10) in the cable processing machine (90) has at least one frame-supported, movable gripper (11, 11a, 11b, 11c, 20a, 20b, 20c, 20e, 20f) for the cable (80, 80a), and
an output side (95b) for discharging a processed cable (80, 80a), wherein the cable transport device (10) is equipped with a cable conveying device (320a, 320b) configured as a multiple-store device (30a, 30b) which has a plurality of cable holders (32, 32a, 32b), and wherein at least the at least one gripper (20a, 20d, 20e, 20f) is configured as a transfer gripper, preferably with the aid of a frame-supported transfer mechanism (22a, 22d), to remove one of the cables (80, 80a) after the other from the respective cable holder (32, 32a, 32b) and feed it to at least one of the cable processing stations (70a, 70b) and/or to a further gripper (11a, 11b, 11c, 20b, 20c, 20e, 20f), which further gripper (11a, 11b, 11c, 20b, 20c, 20e, 20f) is configured to be movable using a further frame-supported transfer mechanism (11, 12a, 12b, 22b, 22c) in order to transfer the cable (80, 80a) to one of the cable processing stations (70a, 70b), wherein the multiple-store device (30a, 30b) is configured as an autonomous or guided transporter (34).

46. The cable processing system according to claim 45, wherein the cable conveying device (320a, 320b) is configured as a conveyor belt on which the cable holders (32a) are attached, preferably with at least two cable holders (32a) spaced apart from one another along the cable (80) for at least one each of the cable ends of the cable (80).

47. The cable processing system according to claim 45, wherein the cable conveying device (320a, 320b) can be docked by means of a docking mechanism (300a) on the input side (95a) and/or the output side (95b) of the cable processing machine (90) in a defined positional relationship, wherein the cable conveying device (320a, 320b) is configured to be mobile with respect to the cable processing machine (90).

48. The cable processing system according to claim 45, wherein the transporter (34) is movable independently of the cable processing machine (90) and is configured as one of a wagon, a trolley and a gondola.

49. The cable processing system according to claim 45, wherein the transporter (34) is configured with a travel drive device for movement of the transporter (34) and is equipped as an autonomous or guided vehicle with a drive controller (35) for autonomous navigation, wherein the drive controller (35) of the transporter (34) is configured for communication with the machine controller and/or with a higher-level control system or that the transporter (34) is configured to be coupled and moved with an autonomous transport system of a factory.

50. The cable processing system according to claim 45, wherein the cable conveying device (320a, 320b) has a local drive for conveying the cables (80, 80a) in the multiple-store device (30a, 30b) and is connected to a-preferably local-controller (35) which interacts with the machine controller in an operating state.

51. The cable processing system according to claim 45, wherein in an area of the cable conveying device (320a, 320b) this comprises at least one external gripper (4020), preferably outside a housing (91) of the cable processing machine, which is arranged and configured in such a manner that this operates the removal area (321b) and/or the depositing area (321a), in particular provides a transfer of the cable (80, 80a) from or to an external, ceiling or floor-bound loading or unloading wagon (430a, 430b) outside the cable processing machine (90).

52. A method for the automatic processing of cable ends of heavy, rigid cables (80, 80a), the method comprising
taking up a plurality of the cables (80, 80a) in a plurality of cable holders (32a, 32b) of a multiple-store device (30a) configured as a cable conveying device (320a), which is configured as an autonomous or guided transporter (34),
mechanically removing of at least one cable (80, 80a) or cable end of one of the cables (80, 80a) from the multiple-store device (30a) by means of a handover and transfer gripper (20d, 20e, 20f) of the cable processing machine (90),
feeding the cable (80, 80a) or cable end to at least a first cable processing station (70a) by the handover and transfer gripper (20d, 20e, 20f),
processing the cable (80, 80a) or cable end in the first cable processing station (70a),
transferring the cable (80, 80a) or cable end from the first cable processing station (70a) to at least a second cable processing station (70b) by the handover and transfer gripper (20d, 20e, 20f),
processing the cable (80, 80a) or cable end in the second cable processing station (70b),
removing the processed cable (80, 80a) or cable end from the second cable processing station (70b) by the handover and transfer gripper (20d, 20e, 20f), wherein a single gripper is optionally configured as the handover and transfer gripper (20d, 20e, 20f).

53. The method according to claim 52, wherein the mechanical removal with a first gripper as a handover gripper (20a, 20e) of the cable processing machine (90) is accomplished by a transfer of the cable (80, 80a) or cable end from the first handover gripper (20a, 20e) to a first transfer gripper (11), and feeding the cable (80, 80a) or cable end to the first cable processing station (70a) by the first transfer gripper (11), and wherein after processing the cable, the cable (80, 80a) or cable end is transferred from the first cable processing station (70a) into the at least one second cable processing station (70b) by a second transfer gripper (11), and the processed cable (80, 80a) or cable end is removed from the second cable processing station (70b) by a third transfer gripper (11) with a handover of the cable (80, 80a) or cable end from the last-mentioned transfer gripper (11) to a second handover gripper (20b, 20f) takes place, wherein in particular a movement of each of the grippers (11, 20a, 20b, 20e, 20f) is accomplished with the aid of at least one transfer drive (12, 22a) associated therewith.

54. The method according to claim 52, wherein a movement of the multiple-store device (30a) outside the cable processing machine (90) and a docking of the multiple-store device (30a) on an input side (95a) of a cable processing machine (90) is accomplished.

55. The method according to claim 52, wherein a floor or ceiling-bound spatial movement of the multiple-store device (30a, 30b) takes place in a factory environment by means of autonomously controlled transporters (34), which transporters (34) are configured for docking and undocking on the cable processing machine (90).

56. The method according to claim 52, wherein an infeed and/or outfeed of the cable (80, 80a) with at least one external gripper (4020) outside a housing (91), which external gripper (4020) transfers a cable (80, 80a) between an external ceiling or floor-bound loading or unloading wagon (430a, 430b) outside the cable processing machine (90) and a removal area (321b) and/or insertion area (321a) of the multiple-store device (320a, 320b) located outside the housing (91).

57. An infeed system for heavy, rigid cables (80, 80a) to a cable processing machine (90) according to claim 45 for the automatic processing of cable ends of the cables (80, 80a) in at least one cable processing station (70a, 70b) of the cable processing machine (90), wherein a multiple-store device (30a), which is configured as an autonomous or guided transporter (34), which can be detachably docked to the cable processing machine (90) with a docking mechanism (300a) between the transporter (34) and an input side (95a) of the cable processing machine, wherein the multiple-store device (30a) has a plurality of cable holders (32a), which cable holders (32a) are configured in such a manner that one of the cable ends is removable therefrom mechanically by a cable transport device (10) of the cable processing machine (90) and can be fed for processing of the cable ends to several cable processing stations (70a, 70b) wherein the transporter (34) is configured such that during cable processing the multiple-store device (30a) remains docked on the input side (95a) as long as it still contains cables (80, 80a) and the cable (80, 80a) is movable separately from the multiple-store device (30a) to and from the cable processing stations (70a, 70b) in the cable processing machine (90).

58. An outfeed system for heavy, relatively rigid cables (80, 80a) from a cable processing machine (90) according to claim 45 for the automatic processing of cable ends of the cables (80, 80a) in at least one cable processing station (70a, 70b) of the cable processing machine (90), wherein a multiple-store device (30b), which is configured as an autonomous or guided transporter (34), which can be detachably docked to the cable processing machine (90) with a docking mechanism (300a) between the transporter (34) and an output side (95b) of the cable processing machine, wherein the multiple-store device (30b) has a plurality of cable holders (32b), which cable holders (32b) are configured such that one of the cable ends can be deposited into them mechanically by a cable transport device (10) of the cable processing machine (90) and is removable from a processing of the cable ends by at least one of the cable processing stations (70a, 70b), wherein the transporter (34) is configured such that during cable processing the multiple-store device (30b) has remained docked on the output side (95b) as long as there is still space for at least one cable (80, 80a) and the cable (80, 80a) is movable separately from the multiple-store device (30b) to and from the cable processing stations (70a, 70b) in the cable processing machine (90).

59. A cable processing system with a cable processing machine (90) according to claim 45.

60. The cable processing system according to claim 59, further comprising at least one of
an infeed system for feeding heavy, rigid cables (80, 80a) to a cable processing machine (90) for the automatic processing of cable ends of the cables (80, 80a) in at least one cable processing station (70a, 70b) of the cable processing machine (90), and
an outfeed system for removing the cables (80, 80a) from the at least one cable processing station (70a, 70b) of the cable processing machine (90), wherein
the infeed system has a multiple-store device (30a), which is configured as an autonomous or guided transporter (34), which can be detachably docked to the cable processing machine (90) with a docking mechanism (300a) between the transporter (34) and an input side (95a) of the cable processing machine, wherein the multiple-store device (30a) has a plurality of cable holders (32a) which are configured in such a manner that one of the cable ends is removable therefrom mechanically by a cable transport device (10) of the cable processing machine (90) and can be fed for processing of the cable ends to the at least one cable processing station (70a, 70b) wherein the transporter (34) is configured such that during cable processing the multiple-store device (30a) remains docked on the input side (95a) as long as it still contains cables (80, 80a) and the cable (80, 80a) is movable separately from the multiple-store device (30a) to and from the at least one cable processing station (70a, 70b) in the cable processing machine (90), and
the outfeed system has a multiple-store device (30b), which is configured as an autonomous or guided transporter (34), which can be detachably docked to the cable processing machine (90) with a docking mechanism (300a) between the transporter (34) and the output side (95b) of the cable processing machine, wherein the multiple-store device (30b) has a plurality of cable holders (32b) which are configured such that one of the cable ends can be deposited into them mechanically by a cable transport device (10) of the cable processing machine (90) and is removable from a processing of the cable ends by the at least one of the cable processing stations (70a, 70b), wherein the transporter (34) is configured such that during cable processing the multiple-store device (30b) has remained docked on the output side (95b) as long as there is still space for at least one cable (80, 80a) and the cable (80, 80a) is movable separately from the multiple-store device (30b) to and from the at least one cable processing station (70a, 70b) in the cable processing machine (90).
